(19) United States
(12) Patent Application Publication
(10) Pub. No.: US 2019/0344342 A1
(43) Pub. Date: Nov. 14, 2019

(54) DENDRONS FOR TUNING THE MAGNETIC PROPERTIES OF NANOPARTICLES AND HYBRID NANOPARTICLES FORMED THEREFROM

(71) Applicants: THE TRUSTEES OF THE UNIVERSITY OF PENNSYLVANIA, Philadelphia, PA (US); CENTRE NATIONAL DE LA RECHERCHE SCIENTIFIQUE, PARIS Cedex 16 (FR); RHODIA OPERATIONS, Paris (FR)

(72) Inventors: Davit JISHKARIANI, Philadelphia, PA (US); Hongseok YUN, Yuseong-gu, Daejeon (KR); Jennifer D. LEE, Philadelphia, PA (US); Bertrand DONNIO, Strasbourg (FR); Christopher B. MURRAY, Bala Cynwyd Lower Merion, PA (US); Ludivine MALASSIS, Philadelphia, PA (US)

(21) Appl. No.: 16/466,798

(22) PCT Filed: Dec. 5, 2017
(86) PCT No.: PCT/US17/64601

§ 371 Date: Jun. 5, 2019

Related U.S. Application Data
(60) Provisional application No. 62/431,515, filed on Dec. 8, 2016.

(51) Int. Cl. B22F 1/00; H01F 1/00; H01F 1/42

(52) U.S. Cl. CPC B22F 1/0088; H01F 1/0054; B82Y 25/00; B22F 1/0018; H01F 1/42

(57) ABSTRACT

The present disclosure relates to a hybrid nanoparticle comprising: (a) a metallic core or a metal oxide core, and (b) at least one dendron attached to the surface of the metallic core or metal oxide core, wherein the at least one dendron is derived from a compound complying with formula (I) or (II), which is described herein, as well as films containing such hybrid nanoparticles. Also described are compounds complying with formula (I) or (II) and their use in forming the hybrid nanoparticles of the present disclosure.

### CROSS REFERENCE TO RELATED APPLICATIONS

This application claims the priority of U.S. Provisional Application No. 62/431,515 filed Dec. 8, 2016, which is hereby incorporated by reference in its entirety.

### FIELD OF THE INVENTION

The present disclosure relates to a hybrid nanoparticle comprising a metallic core or a metal oxide core, and at least one dendron attached to the surface of the metallic core or metal oxide core, wherein the at least one dendron is derived from a compound complying with formula (I) or (II), as described herein. The present disclosure also relates to films containing the hybrid nanoparticles described herein and their use.

### BACKGROUND

Magnetic nanoparticles, such as nanocrystals (NCs), have attracted much recent interest due to their potential applications in data storage, AC electromagnetic devices, bio-imaging, and targeted drug delivery. Collective magnetic properties of NCs depend on the size, shape, chemical composition, and assembly structure of NCs as well as their inter-particle distance (dipole-dipole interactions) which have been studied in terms of DC and AC magnetic properties. Strong dipole-dipole interactions existing among NCs lag the thermal relaxation of NC magnetic moments and therefore ferromagnetic resonance (FMR) frequencies are affected by these interactions. FMR is a phenomenon that external magnetic field energy is absorbed by magnetic materials when the spin relaxation frequency of the magnetic domains coincides with the external AC magnetic field frequency. The FMR limits the operable frequency range of magnetic materials in AC magnetic devices, and increasing FMR limit to higher frequency range (i.e. radio frequency) is of great importance especially for the miniaturization of AC magnetic devices.

Thus, there is an unresolved need for the development of magnetic materials having increased FMR frequencies for use in miniaturized AC magnetic devices operating at radio frequencies as well as methods for tuning the magnetic properties of such materials. Herein, the tuning of the magnetic properties, such as magnetic permeability, of hybrid nanoparticles by using surface binding dendritic ligands is described.

### SUMMARY OF THE INVENTION

In a first aspect, the present disclosure relates to a hybrid nanoparticle comprising:
(a) a metallic core or a metal oxide core, and
(b) at least one dendron attached to the surface of the metallic core or metal oxide core,
   wherein the at least one dendron is derived from a compound complying with formula (I) or (II):

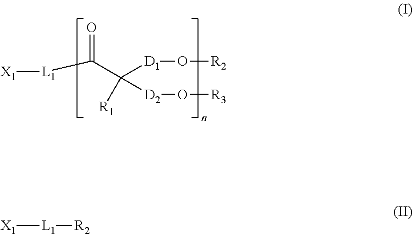

wherein
   each occurrence of R₁ is H or C₁-C₂₀ alkyl,
   each occurrence of D₁ and D₂ are each, independently, C₁-C₂₀ alkylene,
   each occurrence of L₁ is C₁-C₂₀ alkylene,
   each occurrence R₂ and R₃ are each, independently, H, C₁-C₃₈ alkyl, C₂-C₃₈ alkenyl, or C₂-C₃₈ alkynyl,
   n is from 1 to 6;
   X₁ is —COOR₅, —PO₃R₆R₇, —CN,

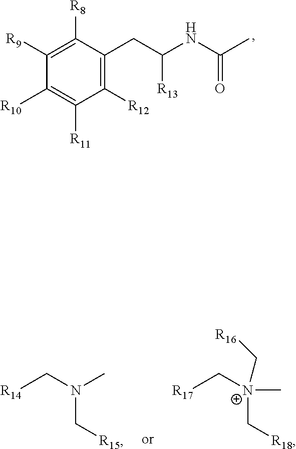

wherein
   R₅, R₆, and R₇, are each, independently, H or hydrocarbyl;
   R₈, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl; and
wherein R₁, D₁, and D₂, L₁, R₂, and R₃, are each optionally interrupted by one or more divalent moieties.

In a second aspect, the present disclosure relates to a film comprising a plurality of hybrid nanoparticles described herein.

In a third aspect, the present disclosure relates to a compound complying with formula (I) or (II):

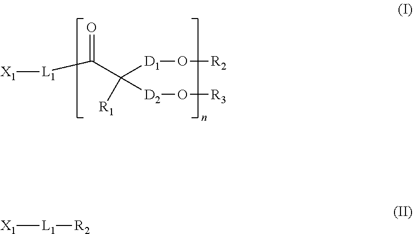

wherein
   each occurrence of R₁ is H or C₁-C₂₀ alkyl,
   each occurrence of D₁ and D₂ are each, independently, C₁-C₂₀ alkylene,
   each occurrence of L₁ is C₁-C₂₀ alkylene,
   each occurrence R₂ and R₃ are each, independently, H, C₁-C₃₈ alkyl, C₂-C₃₈ alkenyl, or C₂-C₃₈ alkynyl,
   n is from 1 to 6;
   X₁ is —COOR₅, —PO₃R₆R₇, —CN,

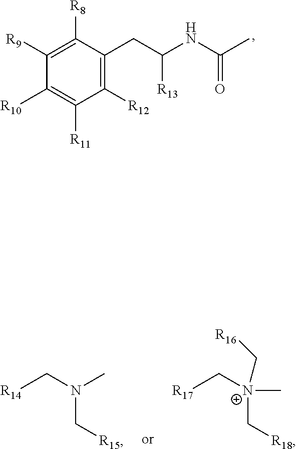

wherein
   R₅, R₆, and R₇, are each, independently, H or hydrocarbyl;
   R₈, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl; and
wherein R₁, D₁, and D₂, L₁, R₂, and R₃, are each optionally interrupted by one or more divalent moieties.

In a fourth aspect, the present disclosure relates to a method for tuning the magnetic permeability of a nanoparticle, the method comprising: contacting the nanoparticle with a compound complying with formula (I) or (II), as described herein.

### BRIEF DESCRIPTION OF THE FIGURES

FIG. 1 schematically shows (a) the general structure of a dendrimer, (b) the spatial arrangement of four different units which make up a typical dendrimer, and (c) segments of dendrons in a typical dendrimer.

FIG. 2 shows TEM images of monolayer of (a) as-synthesized Ni NCs, (b) Ni@G0, (c) Ni@G1, (d) Ni@G2, (e) Ni@G3 and (f) Mw/inter-particle distance (Mw=molecular weight). A dashed line serves as eye guide only.

FIG. 3 shows an overlay of ¹H spectra of compounds 13-16, also referred to as G0-G3, respectively, and a fragment of 16 (G3) with full signal assignments.

FIG. 4 shows (a) low and (b) high magnification TEM images of as-synthesized MZF NCs and a (c) low and (d) high magnification images of same NCs after ligand exchange with compound 17. Inset of FIG. 4a is a selected area electron diffraction pattern of the NCs.

FIG. 5 shows the distribution of inter-particle distance before and after ligand exchange.

FIG. 6 shows ZFC curves of MZF NCs before (squares) and after (circles) the ligand exchange with compound 17.

FIG. 7 shows the (a) real and b) imaginary part of the relative permeability, and c) loss tangent of MZF NCs before (square) and after (circle) the ligand exchange with compound 17 from 10 MHz to 500 MHz.

FIG. 8 shows a normalized μᵣ′ (μᵣ′/μᵣ′ᵢₙᵢₜᵢₐₗ) plot.

FIG. 9 shows the DSC traces of inventive compounds 13-17 described herein.

### DETAILED DESCRIPTION

As used herein, the terms “a”, “an”, or “the” means “one or more” or “at least one” unless otherwise stated.

As used herein, the term “comprises” includes “consists essentially of” and “consists of.” The term “comprising” includes “consisting essentially of” and “consisting of.”

Throughout the present disclosure, various publications may be cited and/or may be incorporated by reference. Should the meaning of any language in such publications incorporated by reference conflict with the meaning of the language of the present disclosure, the meaning of the language of the present disclosure shall take precedence, unless otherwise indicated.

As used herein, the terminology “(Cx-Cy)” in reference to an organic group, wherein x and y are each integers, means that the group may contain from x carbon atoms to y carbon atoms per group.

As used herein, the term “alkyl” means a monovalent straight or branched saturated hydrocarbon radical, more typically, a monovalent straight or branched saturated (C₁-C₄₀) hydrocarbon radical, such as, for example, methyl, ethyl, n-propyl, isopropyl, n-butyl, isobutyl, tert-butyl, hexyl, 2-ethylhexyl, octyl, hexadecyl, octadecyl, eicosyl, behenyl, tricontyl, and tetracontyl.

As used herein, the term “alkenyl” means a monovalent straight or branched unsaturated hydrocarbon radical, more typically, a monovalent straight or branched unsaturated (C₂-C₄₀) hydrocarbon radical, having one or more double bonds.

Double bonds may have E or Z configuration, based on IUPAC designation, and may be isolated or conjugated. Examples of alkenyl groups include, but are not limited to, ethenyl, n-butenyl, linoleyl, and oleyl.

As used herein, the term “alkynyl” means a monovalent straight or branched unsaturated hydrocarbon radical, more typically, a monovalent straight or branched unsaturated (C₂-C₄₀) hydrocarbon radical, having one or more triple bonds. Triple bonds may be isolated or conjugated. Examples of alkynyl groups include, but are not limited to, ethynyl, n-propynyl, and n-butynyl.

As used herein, the term “alkylene” means a divalent straight or branched saturated hydrocarbon radical, more typically, a divalent straight or branched saturated (C₁-C₄₀) hydrocarbon radical, such as, for example, methylene, ethylene, n-propylene, n-butylene, hexylene, 2-ethylhexylene, octylene, hexadecylene, and octadecylene.

Any substituent described herein may optionally be substituted at one or more carbon atoms with one or more, same or different, substituents described herein. For instance, an alkylene group may be further substituted with an alkyl group. Any substituent described herein may optionally be substituted at one or more carbon atoms with one or more substituents selected from the group consisting of halogen, such as, for example, F, Cl, Br, and I; nitro (NO₂), cyano (CN), amino (NH₂), carboxylic and benzoic acids (CO₂H, PhCO₂H) and hydroxy (OH).

The present disclosure relates to a hybrid nanoparticle comprising:
(a) a metallic core or a metal oxide core, and
(b) at least one dendron attached to the surface of the metallic core or metal oxide core,
   wherein the at least one dendron is derived from a compound complying with formula (I) or (II):

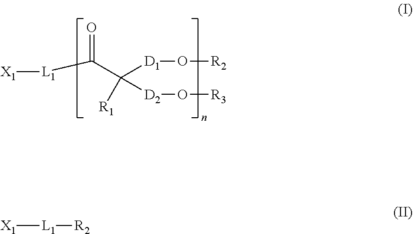

wherein
   each occurrence of R₁ is H or C₁-C₂₀ alkyl,
   each occurrence of D₁ and D₂ are each, independently, C₁-C₂₀ alkylene,
   each occurrence of L₁ is C₁-C₂₀ alkylene,
   each occurrence R₂ and R₃ are each, independently, H, C₁-C₃₈ alkyl, C₂-C₃₈ alkenyl, or C₂-C₃₈ alkynyl,
   n is from 1 to 6;
   X₁ is —COOR₅, —PO₃R₆R₇, —CN,

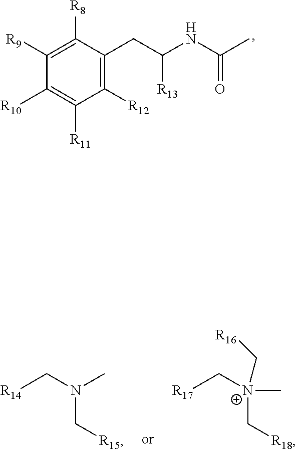

wherein
   R₅, R₆, and R₇, are each, independently, H or hydrocarbyl;
   R₈, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl; and
wherein R₁, D₁, and D₂, L₁, R₂, and R₃, are each optionally interrupted by one or more divalent moieties.

The metallic core or metal oxide core comprises a metal, or an alloy or intermetallic comprising a metal. Metals include, for example, main group metals such as, e.g., lead, tin, bismuth, antimony and indium, and transition metals, e.g., a transition metal selected from the group consisting of gold, silver, copper, nickel, cobalt, palladium, platinum, iridium, osmium, rhodium, ruthenium, rhenium, vanadium, chromium, manganese, niobium, molybdenum, tungsten, tantalum, titanium, zirconium, zinc, mercury, yttrium, iron and cadmium. The metallic core may comprise or consist of a metal, or an alloy or intermetallic comprising a metal.

In an embodiment, the metallic core or metal oxide core comprises a transition metal, typically at least two different transition metals.

In an embodiment, the metallic core or metal oxide core comprises a transition metal, typically at least two different transition metals, more typically selected from the group consisting of Mn, Fe, Co, Ni, Cu, and Zn.

In an embodiment, the hybrid nanoparticle comprises a metallic core, which comprises nickel.

In an embodiment, the hybrid nanoparticle comprises a metal oxide core.

In another embodiment, the metal oxide core comprises at least 3 different transition metals. Typically, the metal oxide core has a formula M¹ₓM²_{y}M³_{z}O₄, wherein M¹, M², and M³, are each, independently, selected from the group consisting of Mn, Fe, Co, Ni, Cu, and Zn; and the sum of x, y, and z is 3.

In another embodiment, the metal oxide core comprises manganese, zinc, and iron.

The hybrid nanoparticle of the present disclosure comprises at least one dendron derived from a compound complying with formula (I) or (II) attached to the surface of the metallic or metal oxide core.

Dendritic polymers include generally any of the known dendritic architectures including dendrimers, dendrons, typically regular dendrons, controlled hyperbranched polymers, dendrigrafts, and random hyperbranched polymers. Dendritic polymers are polymers with densely branched structures having a large number of reactive groups. A dendritic polymer includes several layers, or generations, of repeating units which all contain one or more branch points. Dendritic polymers, including dendrimers and hyperbranched polymers, are prepared by condensation reactions of monomeric units having at least two reactive groups. In general, dendrimers comprise a plurality of dendrons that emanate from a common core, which can be a single atom or a group of atoms. Each dendron generally consists of terminal surface groups, interior branch junctures having branching functionalities greater than or equal to two, and divalent connectors that covalently connect neighboring branching junctures.

Dendrons and dendrimers can be prepared by convergent or divergent synthesis. Divergent synthesis of dendrons and dendrimers involves a molecular growth process which occurs through a consecutive series of geometrically progressive step-wise additions of branches upon branches in a radially outward molecular direction to produce an ordered arrangement of layered branched shells. Convergent synthesis of dendrimers and dendrons involves a growth process which begins from what will become the surface of the dendron or dendrimer and progresses radially in a molecular direction toward a focal point or core. The dendritic polymers may be ideal or non-ideal, i.e., imperfect or defective. Imperfections are normally a consequence of either incomplete chemical reactions, or unavoidable competing side reactions.

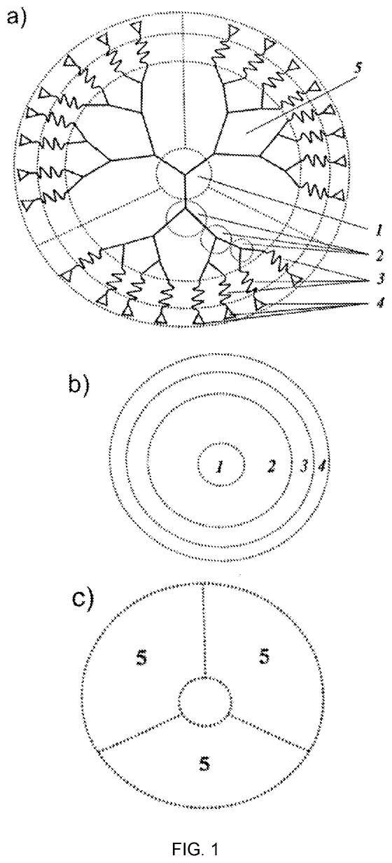

The general structure of dendrimers is schematically shown in FIG. 1a. The center of the structure is the core 1, which is typically non-metallic. In the example of FIG. 1a the core has three arms, or dendrons. However, in general the core can have any number of dendrons. Herein, the term “dendron” refers to a dendritic arm that is attached to a core, which core may be non-metallic or metallic.

Each dendron of the core begins with a first “shell” of repeating units 2 connected, each of which branches into at least two new branches. When going from the core to the outside of the structure, the example shown in FIG. 1a comprises altogether three shells of repeating units. Therefore, the dendrimer structure shown is called a generation-3 (G3) dendrimer. According to the present disclosure, dendrimers and dendrons of various generations can be used. Typically, generations 1-6, still more typically, generations 1-4, are used. In the example shown in FIG. 1a, since each repeating unit shown branches into two limbs, each shell of repeating units is doubling the total number of branches. Therefore the whole number of branches at the surface of the structure is 24 (3×2ⁿ, wherein n is the generation). In general, it is also possible to have dendrimer structures in which each repeating unit branches into more than two limbs. When going from the inside to the outside of the structure shown in FIG. 1a, the last shell of repeating units is optionally followed by a shell of spacer units 3. As seen in the figure, to each of the 24 branches a spacer unit is connected. These optional spacer units have the function to bind the capping groups 4 to the outer shell of repeating units. Typically, the capping groups 4 are connected directly to the last shell of the repeating units.

FIG. 1b schematically shows the spatial arrangement of the four different units, which form a typical dendrimer structure. In center is the core 1, which is surrounded by at least one shell of repeating units 2. The shells of repeating units are followed by a shell of optional spacer units 3, which at the outside of the dendrimer is surrounded by an outer shell of capping groups 4. The shells of repeating units may be formed by chemically and structurally identical units or by chemically and/or structurally different units. The repeating units may be different from shell to shell and/or may differ within one shell. In addition, the dendrimer structure may comprise chemically and/or structurally identical or different capping groups and optional spacer units. The repeating units may be attached to the core through covalent bonds such as carbon-carbon bonds or functional bonds, for example, ester bonds, amide bonds, and thioether bonds.

According to the number of dendrons of the core 1, the dendrimer structure may be divided into dendrons 5 as shown in FIG. 1c. If the dendrimer is synthesized by a convergent approach, the chemical composition and/or the structural features of the dendrons (repeating units, the optional spacer units, and/or the capping groups) may differ from dendron to dendron.

The outer surface shell of dendritic polymers, including dendrimers and dendrons, may contain either chemically reactive or passive functional capping groups. Chemically reactive capping groups can be used for further extension of dendritic growth or for modification of dendritic molecular surfaces. The chemically passive capping groups may be used to physically modify dendritic surfaces, such as to adjust the ratio of hydrophobic, or lipophilic, to hydrophilic, or lipophobic, terminals, and/or to improve the solubility of the dendritic polymer, dendrimer, or dendron, for a particular solvent.

As used herein, the phrase “interrupted by one or more divalent moieties” when used in relation to a substituent means a modification to the substituent in which one or more divalent moieties are inserted into one or more covalent bonds between atoms. The interruption may be in a carbon-carbon bond, a carbon-hydrogen bond, a carbon-heteroatom bond, a hydrogen-heteroatom bond, or heteroatom-heteroatom bond. The interruption may be at any position in the substituent modified, even at the point of attachment to another structure.

The one or more divalent moieties may be selected from the group consisting of the following:

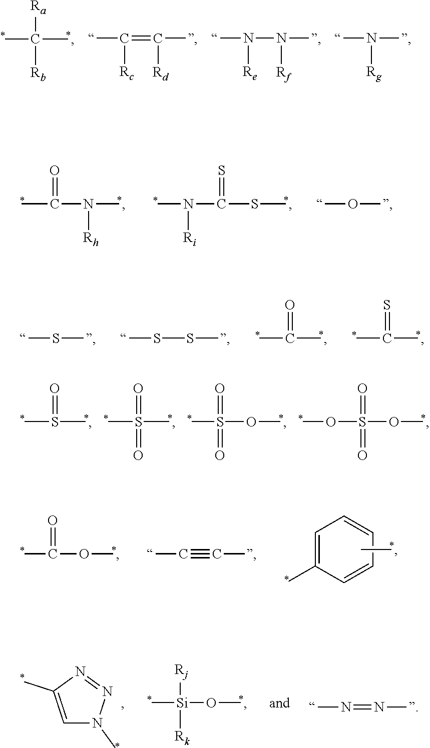

As used herein, the asterisks indicate a point of connection.

Each occurrence of Rₐ-Rₖ, are each, independently H, halogen, typically F, or alkyl. When any of Rₐ-Rₖ is alkyl, the alkyl group may optionally be interrupted by one or more divalent moieties defined herein.

The generation n is, typically, 1 to 6, more typically, 1 to 4, still more typically, 1-3. In an embodiment, n is 2.

In an embodiment, X₁ is —COOR₅ or —PO₃R₆R₇.

In an embodiment, R₁ is methyl.

In an embodiment, D₁ and D₂ are each methylene.

In an embodiment, R₂ and R₃ are each C₁₇-alkyl. In another embodiment, R₂ and R₃ are each C₁₇-alkyl interrupted by

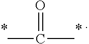

In an embodiment, L₁ is C₁₂-alkylene. In another embodiment, L₁ is C₁₂-alkylene interrupted by —O— and

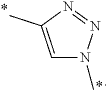

The present disclosure relates to a film comprising a plurality of hybrid nanoparticles described herein. The plurality of hybrid nanoparticles may comprise hybrid nanoparticles that have the same or different effective diameter.

In an embodiment, the plurality of hybrid nanoparticles comprises hybrid nanoparticles having the same effective diameter.

In another embodiment, the plurality of hybrid nanoparticles comprises hybrid nanoparticles that have different effective diameters.

Various properties of the hybrid nanoparticles of the present disclosure, and of films containing the hybrid nanoparticles, may be determined using methods and instruments known to those of ordinary skill in the art.

The effective diameter of the hybrid nanoparticles may be determined using one or more techniques and instruments known to those of ordinary skill in the art. For example, a combination of techniques including NMR and UV-Vis spectroscopies, thermogravimetric analysis (TGA), transmission electron microscopy (TEM) and small-angle X-ray scattering (SAXS) may be used. TGA may be carried out using a TA Instruments TGA Q600 apparatus in the temperature range of 25° C. to 500° C. under N₂ flow at a heating rate of 30° C./min, with thermal transitions being determined on a TA Instruments Q2000 differential scanning calorimeter (DSC) equipped with a liquid nitrogen cooling system with 10° C./min heating and cooling rates. SAXS may be performed using a Multi-angle X-ray scattering instrument equipped with a Bruker Nonius FR591 40 kV rotating anode generator operated at 85 mA, Osmic Max-Flux optics, 2D Hi-Star Wire detector, and pinhole collimation, with an evacuated beam path.

The present disclosure also relates to a compound complying with formula (I) or (II):

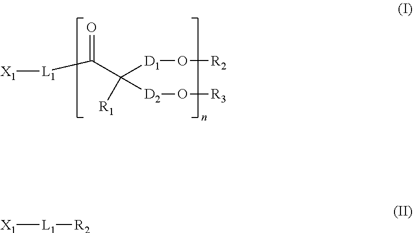

wherein
   each occurrence of R₁ is H or C₁-C₂₀ alkyl,
   each occurrence of D₁ and D₂ are each, independently, C₁-C₂₀ alkylene,
   each occurrence of L₁ is C₁-C₂₀ alkylene,
   each occurrence R₂ and R₃ are each, independently, H, C₁-C₃₈ alkyl, C₂-C₃₈ alkenyl, or C₂-C₃₈ alkynyl, n is from 1 to 6;
   X₁ is —COOR₅, —PO₃R₆R₇, —CN,

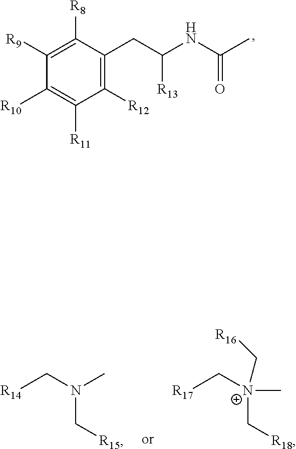

wherein
   R₅, R₆, and R₇, are each, independently, H or hydrocarbyl;
   R₈, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl; and
wherein R₁, D₁, and D₂, L₁, R₂, and R₃, are each optionally interrupted by one or more divalent moieties.

In an embodiment, n is from 1 to 3.

In an embodiment, n is 2.

In an embodiment, X₁ is —COOR₅ or —PO₃R₆R₇.

In an embodiment, R₁ is methyl.

In an embodiment, D₁ and D₂ are each methylene.

In an embodiment, R₂ and R₃ are each C₁₇-alkyl interrupted by

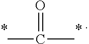

In an embodiment, L₁ is C₁₂-alkylene interrupted by —O— and

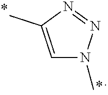

The compounds complying with formula (I) or (II) are may be made according to methods known to those of ordinary skill in the art.

For example, a suitable method comprises:
reacting a compound represented by the structure of formula (III):

X₁-G₁
wherein X₁ is —COOR₅, —PO₃R₆R₇, —CN,

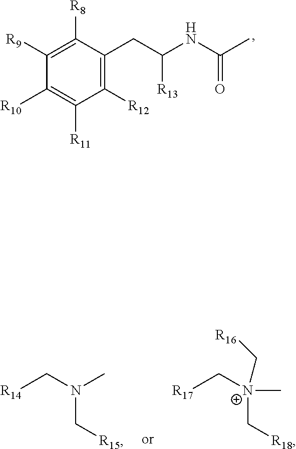

wherein
R₅, R₆, and R₇, are each, independently, H or hydrocarbyl; and
R₈, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl;
with a compound represented by the structure of formula (IV) or (V):

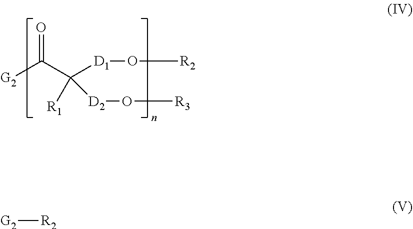

wherein
each occurrence of R₁ is H or C₁-C₂₀ alkyl,
each occurrence of D₁ and D₂ are each, independently, C₁-C₂₀ alkylene,
each occurrence R₂ and R₃ are each, independently, H, C₁-C₃₈ alkyl, C₂-C₃₈ alkenyl, or C₂-C₃₈ alkynyl,
n is from 1 to 6;
   wherein R₁, D₁, and D₂, R₂, and R₃, are each optionally interrupted by one or more divalent moieties defined herein;
each occurrence of G₁ is a substituent comprising a reactive group capable of reacting with the reactive group in G₂, and
G₂ is a substituent comprising a reactive group capable of reacting with the reactive group in G₁.

The generation n is, typically, 1 to 6, more typically, 1 to 4, still more typically, 1 to 3.

In an embodiment, n is 2.

In an embodiment, X₁ is —COOR₅ or —PO₃R₆R₇.

In an embodiment, R₁ is methyl.

In an embodiment, D₁ and D₂ are each methylene.

In an embodiment, R₂ and R₃ are each C₁₇-alkyl. In another embodiment, R₂ and R₃ are each C₁₇-alkyl interrupted by

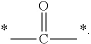

G₁ is a substituent comprising a reactive group capable of reacting with the reactive group in G₂, and G₂ is a substituent comprising a reactive group capable of reacting with the reactive group in G₁.

Typically, G₁ is a C₁-C₁₅-alkyl group, optionally interrupted by one or more divalent moieties defined herein, comprising a reactive group capable of reacting with the reactive group in G₂.

In an embodiment, G1 comprises a reactive group selected from the group consisting of —X, —NH₂, —N₃, —(C═O)X, -Ph(C═O)X, —SH, —CH═CH₂, —C≡CH; wherein X is a leaving group.

In an embodiment, G₁ is a C₁-C₁₅-alkyl group comprising a —N₃ group.

Typically, G₂ is a C₁-C₁₅-alkyl group, optionally interrupted by one or more divalent moieties defined herein, comprising a reactive group capable of reacting with the reactive group in G₁.

In an embodiment, G₂ comprises a reactive group selected from the group consisting of —(C═O)X, —CH═CH₂, —C≡CH, —NH₂, —N₃, -Ph(C═O)X, —SH, —X, —NCO, —NCS; wherein X is a leaving group.

Leaving groups are known to those of ordinary-skill in the art. Suitable leaving groups include, but are not limited to, halides, such as, fluoride, chloride, bromide, and iodide; alkyl and aryl sulfonates, such as methanesulfonate (mesylate) and p-toluenesulfonate (tosylate); and hydroxide.

In an embodiment, G₂ is a C₁-C₁₅-alkyl group comprising a —C≡CH group, and is interrupted by a —O— group.

According to the present disclosure, it is understood that the reactive groups on G₁ and G₂ may be reversed.

The compounds represented by the structures of formulae (III), (IV), and (V) may be obtained from commercial sources or synthesized according to synthetic methods well-known to those of ordinary skill in the art. Suitable synthetic methods known to those of ordinary skill in the art are described in well-known texts, including, but not limited to, M. B. Smith “March's Advanced Organic Chemistry: Reactions, Mechanisms, and Structure”, 7^{th} edition (Wiley); and Carey and Sunberg “Advanced Organic Chemistry, Part A: Structure and Mechanisms”, 5^{th} edition (Springer) and “Advanced Organic Chemistry: Part B: Reaction and Synthesis”, 5^{th} edition (Springer).

Any suitable reaction conditions, including reaction vessels and equipment, for the reacting step may be selected by the ordinary-skilled artisan according to concepts known in the chemical arts.

The hybrid nanoparticle according to the present disclosure may be made by a method comprising:
(i) producing a compound of formula (I) or (II) as described herein, and
(ii) contacting the compound of formula (I) or (II) produced in step (i) with a metallic or metal oxide nanoparticle; thereby producing the hybrid nanoparticle.

Production of the compound complying with formula (I) or (II) may be achieved using any method known to the ordinarily-skilled artisan. Typically, the compound complying with formula (I) or (II) is produced as described herein.

Subsequent to producing the compound complying with formula (I) or (II), said compound is contacted with a metallic or metal oxide nanoparticle. The metallic or metal oxide nanoparticle becomes the metallic core or metal oxide core of the hybrid nanoparticle.

The metallic nanoparticle or metal oxide nanoparticle may be obtained from commercial sources or made according to methods known in the art. The metallic nanoparticle comprises a metal, or an alloy or intermetallic comprising a metal.

Metals include, for example, main group metals such as, e.g., lead, tin, bismuth, antimony and indium, and transition metals, e.g., a transition metal selected from the group consisting of gold, silver, copper, nickel, cobalt, palladium, platinum, iridium, osmium, rhodium, ruthenium, rhenium, vanadium, chromium, manganese, niobium, molybdenum, tungsten, tantalum, titanium, zirconium, zinc, mercury, yttrium, iron and cadmium. The metallic nanoparticle may comprise or consist of a metal, or an alloy or intermetallic comprising a metal.

In an embodiment, the metallic nanoparticle or metal oxide nanoparticle comprises a transition metal, typically at least two different transition metals.

In an embodiment, the metallic nanoparticle or metal oxide nanoparticle comprises a transition metal, typically at least two different transition metals, more typically selected from the group consisting of Mn, Fe, Co, Ni, Cu, and Zn.

In an embodiment, the metallic nanoparticle comprises nickel.

In an embodiment, the metal oxide nanoparticle comprises at least 3 different transition metals. Typically, the metal oxide nanoparticle has a formula M¹ₓM²_{y}M³_{z}O₄, wherein M¹, M², and M³, are each, independently, selected from the group consisting of Mn, Fe, Co, Ni, Cu, and Zn; and the sum of x, y, and z is 3.

In another embodiment, the metal oxide nanoparticle comprises manganese, zinc, and iron.

The metallic or metal oxide nanoparticle, prior to contact with the compound complying with formula (I) or (II), may optionally comprise organic capping groups, such as, for example, oleylamine or CTAB.

The contacting step may be carried out according to any method. For example, the metallic or metal oxide nanoparticle may be suspended in one or more solvents described herein to form a first mixture. The compound complying with formula (I) or (II) may be dissolved in one or more solvents described herein to form a second mixture. The first and second mixtures may then be combined and stirred, thereby producing the hybrid nanoparticle.

The present disclosure relates to a composition comprising at least one hybrid nanoparticle described herein and a liquid carrier.

The composition of the present disclosure may be a dispersion in which the at least one hybrid nanoparticle is not solubilized, but suspended in the liquid carrier.

The liquid carrier used in the composition according to the present disclosure comprises an organic solvent or a blend of organic solvents. In an embodiment, the composition consists essentially of or consists of an organic solvent or a blend of organic solvents. The blend of organic solvents comprises two or more organic solvents.

Organic solvents suitable for use in the liquid carrier may be polar or non-polar, protic or aprotic solvents. Examples of suitable organic solvents include, but are not limited to, chlorinated solvents, such as, for example, chloroform and dichloromethane; alkane solvents, such as, for example, pentane, hexane, heptane, and isomers thereof; and alcohols, such as, for example, n-propanol, isopropanol, ethanol, and methanol, and alkylene glycol monoethers.

In an embodiment, the liquid carrier comprises hexane, or isomers thereof.

The liquid carrier of the composition according to the present disclosure may further comprise a residual amount of water as a result of, for example, hygroscopic uptake by the solvents of the liquid carrier or carry-over from the reaction medium used to make the metallic nanoparticles. The amount of water in the composition is from 0 to 2% wt., with respect to the total amount of composition. Typically, the total amount of water in the composition is from 0 to 1% wt, more typically from 0 to 0.5% wt, still more typically from 0 to 0.1% wt, with respect to the total amount of the composition. In an embodiment, the composition of the present disclosure is free of water.

The amount of liquid carrier in the composition according to the present disclosure is from about 50 wt. % to about 99 wt. %, typically from about 75 wt. % to about 99 wt. %, still more typically from about 90 wt. % to about 99 wt. %, with respect to the total amount of composition.

The composition described herein may be used to produce the film described herein.

A suitable method comprises:
(i) coating a composition described herein on the surface of a liquid immiscible with the liquid carrier of the composition, and
(ii) removing the liquid carrier of the composition, thereby producing the film.

The step of coating a composition described herein on the surface of a liquid immiscible with the liquid carrier of the composition may be achieved using any method known to the ordinarily-skilled artisan. For example, a drop of the composition may be spread on the surface of a liquid immiscible with the liquid carrier of the composition.

The liquid immiscible with the liquid carrier of the composition may be any solvent or blend of solvents that is immiscible with the liquid carrier of the composition. In an embodiment, the liquid immiscible with the liquid carrier of the composition is diethylene glycol.

Subsequent to the coating step, the step of removing the liquid carrier of the composition may be achieved according to any method known to the ordinarily-skilled artisan. For example, the liquid carrier of the composition may be allowed to evaporate under temperatures and pressures selected by the artisan based on the liquid carrier to be removed. In an embodiment, the step of removing the liquid carrier of the composition is carried out under ambient temperature and pressure.

The present disclosure relates to a method for tuning the magnetic permeability of a nanoparticle, the method comprising: contacting the nanoparticle with a compound complying with formula (I) or (II).

In an embodiment, the nanoparticle is a metal oxide nanoparticle.

In an embodiment, the contacting step is a ligand exchange.

The magnetic characteristics, such as zero-field-cooling (ZFC) curves and relative magnetic permeability, of the inventive hybrid nanoparticles may be determined using methods known to those of ordinary skill in the art. For example, ZFC curves may be collected on a superconducting quantum interference device (SQUID).

The relative magnetic permeability (μᵣ) of the inventive hybrid nanoparticles may be measured using any known method. A suitable method comprises depositing the material into a toroidal-shaped sample holder and measuring the reactance and resistance of the sample in the frequency range of 1-500 MHz in log frequency on a network analyzer. The reactance and resistance values are then converted into the real (μᵣ′) and imaginary (μᵣ″) parts of the permeability using equation (1),

$${μ}_{r} = ( 1 + \frac{{X}_{m}}{f {μ}_{0} h ln \frac{c}{b}} ) - j \frac{{R}_{m}}{f {μ}_{0} h ln \frac{c}{b}} = {μ}_{r}^{′} - j {μ}_{r}^{″} \qquad ( 1 )$$

where Xₘ is the reactance, Rₘ is the resistance, f is the frequency of the AC field, μ₀ is the vacuum permeability, h is the height, c is the outer diameter and b is the inner diameter of the toroidal sample.

In an embodiment, the magnetic permeability of the nanoparticle is reduced.

In an embodiment, the FMR frequency is increased.

The hybrid nanoparticles, compositions, methods and processes, and films according to the present disclosure are further illustrated by the following non-limiting examples.

### EXAMPLES

The materials used in the following examples, unless otherwise stated, are summarized below.

Manganese (II) acetylacetonate, zinc (II) acetylacetonate, iron (III) acetylacetonate (99+%), 1-octadecene (technical grade, 90%) were purchased from Acros Organics. Nickel (II) acetylacetonate (95%), trioctylphosphine (97%), benzyl ether (98%), oleic acid (technical grade, 90%) and oleylamine (technical grade, 70%) were purchased from Sigma-Aldrich. All the chemicals were used as received. 2,2-Dimethoxypropane (98+%), bis-MPA (98%), propargyl bromide (80% soln. in toluene), propargyl alcohol (99%), pyridine (reagent), Dowex H⁺ ion exchange resin (200-400 mesh), p-toluenesulfonyl chloride (TsCl, 99+%), copper (II) sulfate pentahydrate (98+), triethylamine (Et₃N, 99%) and oleylamine (80-90%) were purchased from Acros. N,N′-Dicyclohexylcarbodiimide (DCC, 99%), NaN₃ (299.5%), 4-dimethylaminopyridine (DMAP, 99%), stearic anhydride (297%), sodium L-ascorbate (≥299%) and 11-bromo-1-undecanol (98%) were purchased from Aldrich. All chemicals were used as received without further purification. Solvents were ACS grade or higher. CH₂Cl₂ was dried over CaH₂ and freshly distilled before used. HAuCl₄.3H₂O is stored in a 4° C. refrigerator. 12-azidododecanoic acid 5a was made as follows. To a stirred solution of 12-bromododecanoic acid (10 g, 19.2 mmol) in DMF (50 mL) at room temperature was added NaN₃ (3.74 g, 57.6 mmol) as one portion and the resulting mixture was stirred at 90° C. for additional 12 h. The mixture was allowed to cool to room temperature, diluted with EtOAc (200 mL) and washed with water (3×100 mL), 1N HCl (2×100 mL) and Brine (50 mL). Organic fraction was dried over Na₂SO₄ and concentrated under reduced pressure to afford pure 12-azidododecanoic acid 5a as white solid (4.4 g, 95%). ¹H NMR (CDCl₃) δ 3.25 (t, J=7.0 Hz, 2H), 2.34 (t, J=7.5 Hz, 2H), 1.68-1.53 (m, 4H), 1.39-1.24 (m, 14H); ¹³C NMR (CDCl₃) δ 180.39, 51.62, 34.20, 29.56, 29.49, 29.33, 29.26, 29.16, 28.96, 26.84, 24.78.

12-Azidododecylphosphonic acid 5b was purchased from Alfa-Aesar.

In general, unless otherwise stated, ¹H NMR (500 MHz) and ¹³C NMR (126 MHz) spectra were recorded on Bruker UNI500 or BIODRX500 NMR spectrometer. ¹H and ¹³C chemical shifts (5) are reported in ppm while coupling constants (J) are reported in Hertz (Hz). The multiplicity of signals in ¹H NMR spectra is described as “s” (singlet), “d” (doublet), “t” (triplet), “q” (quartet), “p” (pentet), “dd” (doublet of doublets) and “m” (multiplet). All spectra were referenced using solvent residual signals (CDCl₃: ¹H, 67.27 ppm; ¹³C, 677.2 ppm, MeOD: ¹H, 63.31 ppm; ¹³C, δ 49.00 ppm). 2D one bond heteronuclear correlation ¹H-¹³C HSQC experiment was used to confirm NMR peak assignments.

Reaction progress was monitored by thin-layer chromatography using silica gel coated plates or ¹H NMR. Compounds were purified by filtration, precipitation, crystallization and/or flash column chromatography using silica gel (Acros Organics, 90 Å, 35-70 μm) as indicated.

Matrix-assisted laser desorption/ionization time of flight (MALDI-TOF) mass spectrometry was performed on Bruker Ultraflex III (Maldi-Tof-Tof) mass spectrometer using dithranol as matrix.

TEM micrographs were collected using a JEOL 1400 microscope operated at 120 kV. The TEM was calibrated using a MAG*I*CAL® TEM calibration standard.

Zero-field-cooling (ZFC) curves were collected by a Quantum Design MPMS-XL 7T superconducting quantum interference device (SQUID).

The relative magnetic permeability (μᵣ) of the inventive hybrid nanoparticles was measured by a 4395A Agilent network analyzer and a 16454A Agilent magnetic material test fixture. The hybrid NCs, dispersed in hexane, were deposited into a toroidal-shaped sample holder (8 mm OD, 3.2 mm ID, 3 mm height and 2.5 mm depth) and dried. The reactance and resistance of the test fixture were measured in the frequency range of 1-500 MHz in log frequency and converted into the real (μᵣ′) and imaginary (μᵣ″) parts of the permeability using equation (1) as described herein.

### Example 1. Synthesis of Compounds Complying with Formula (I) or (II)

Initially, intermediates 1-4 were prepared using the strategy that utilizes the late stage end-group functionalization of 2,2-bis(hydroxymethyl)-propionic acid (bis-MPA) derived dendrons via stearic anhydride. The general reaction scheme is shown below.

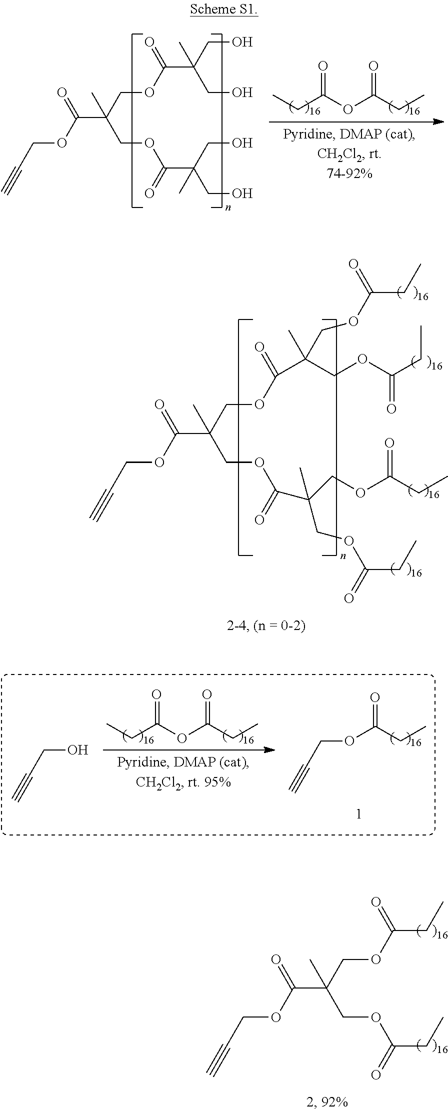

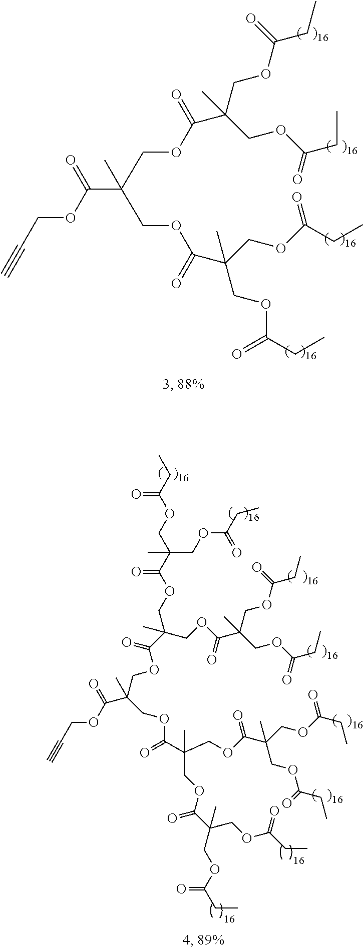

Compound 1 was made according to following scheme 1.

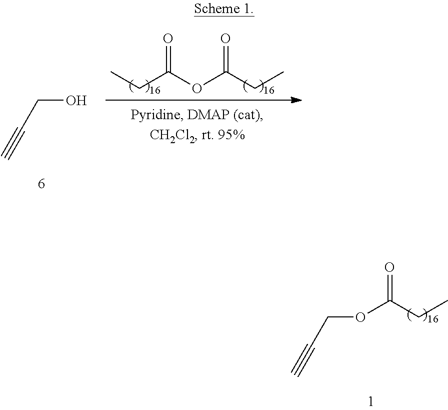

To a stirred solution of propargyl alcohol 6 (1 g, 17.8 mmol), DMAP (0.22 g, 1.8 mmol) and pyridine (2.8 g, 35.6 mmol) in CH₂Cl₂ (50 mL) was added stearic anhydride (11.8 g, 21.4 mmol) and the resulting mixture stirred for 12 h. The reaction mixture was diluted with additional CH₂Cl₂ (50 mL), washed with 1N HCl (3×50 mL), dried over anhydrous MgSO₄, filtered and filtrate concentrated under reduced pressure. The residue was purified by column chromatography (SiO₂, 0-50% EtOAc:hexanes) to afford compound 1 (5.46 g, 95%). ¹H NMR (CDCl₃) δ 4.67 (d, J=2.5 Hz, 2H), 2.46 (t, J=2.5 Hz, 1H), 2.34 (t, J=7.5 Hz, 2H), 1.63 (p, J=7.3 Hz, 2H), 1.33-1.23 (m, 28H), 0.87 (t, J=6.9 Hz, 3H); ¹³C NMR (CDCl₃) δ 173.10, 77.94, 74.80, 51.86, 34.13, 32.07, 29.84, 29.82, 29.80, 29.78, 29.72, 29.57, 29.50, 29.36, 29.20, 24.95, 22.83, 14.25.

Compound 2 was made according to following scheme 2.

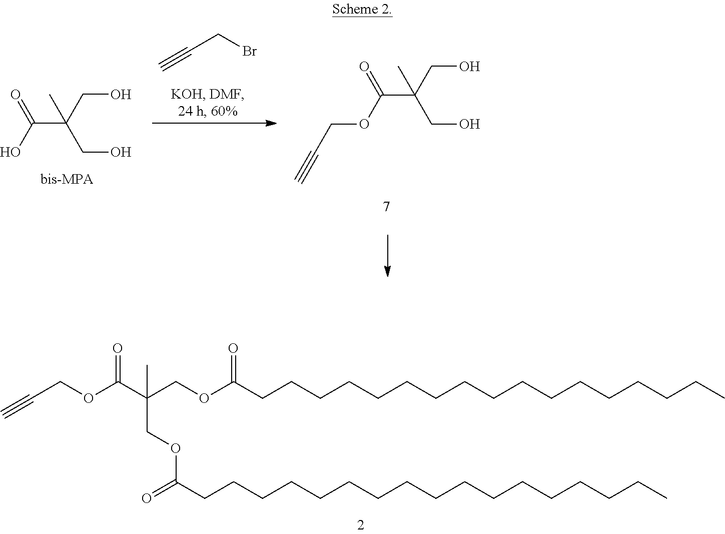

To a stirred solution of bis-MPA (18 g, 136.3 mmol) in DMF (100 mL) was added KOH (8.2 g, 146.6 mmol). The resulting solution was stirred at 100° C. for 2 h after which propargyl bromide (20.3 g, 137 mmol) was added dropwise (over 30 min) and stirring continued for an additional 48 h. The solution was cooled to 23° C., filtered and DMF was evaporated under reduced pressure. The residue was dissolved in chloroform (70 mL), filtered and the filtrate placed in the fridge at −10° C. for 2 h. The resulting white precipitate was quickly filtered and dried to afford prop-2-yn-1-yl 3-hydroxy-2-(hydroxymethyl)-2-methylpropanoate 7 (13.8 g, 60%) as a white solid. ¹H NMR (CDCl₃) δ 4.73 (d, J=2.5 Hz, 2H), 3.88 (d, J=11.4 Hz, 2H), 3.70 (d, J=13.1 Hz, 2H), 3.30-2.74 (m, 2H), 2.49 (t, J=2.4 Hz, 1H), 1.09 (s, 3H); ¹³C NMR (CDCl₃) δ 175.13, 77.47, 75.37, 67.33, 52.56, 49.49, 17.12.

To a stirred solution of 7, DMAP and pyridine in CH₂Cl₂ (50 mL) was added stearic anhydride and the resulting mixture stirred for 12 h. The reaction mixture was diluted with additional CH₂Cl₂ (50 mL), washed with 1N HCl (3×50 mL), dried over anhydrous MgSO₄, filtered and filtrate concentrated under reduced pressure. The residue was purified by column chromatography (SiO₂, 0-50% EtOAc:hexanes) to afford compound 2 (2.3 g, 92%). Compound 2 was further purified by repeated precipitation from CHCl₃/MeOH. ¹H NMR (CHCl₃) δ 4.68 (d, J=2.5 Hz, 2H), 4.23 (d, J=11.0 Hz, 2H), 4.20 (d, J=11.1 Hz, 2H), 2.44 (t, J=2.5 Hz, 1H), 2.27 (t, J=7.6 Hz, 4H), 1.57 (t, J=7.3 Hz, 4H), 1.30-1.20 (m, 59H), 0.85 (t, J=6.9 Hz, 6H); ¹³C NMR (CDCl₃) δ 173.26, 172.14, 77.27, 75.19, 65.19, 52.62, 46.46, 34.19, 32.04, 29.81, 29.79, 29.77, 29.72, 29.58, 29.48, 29.37, 29.23, 24.97, 22.80, 17.77, 14.21.

Compound 3 was made according to following scheme 3.

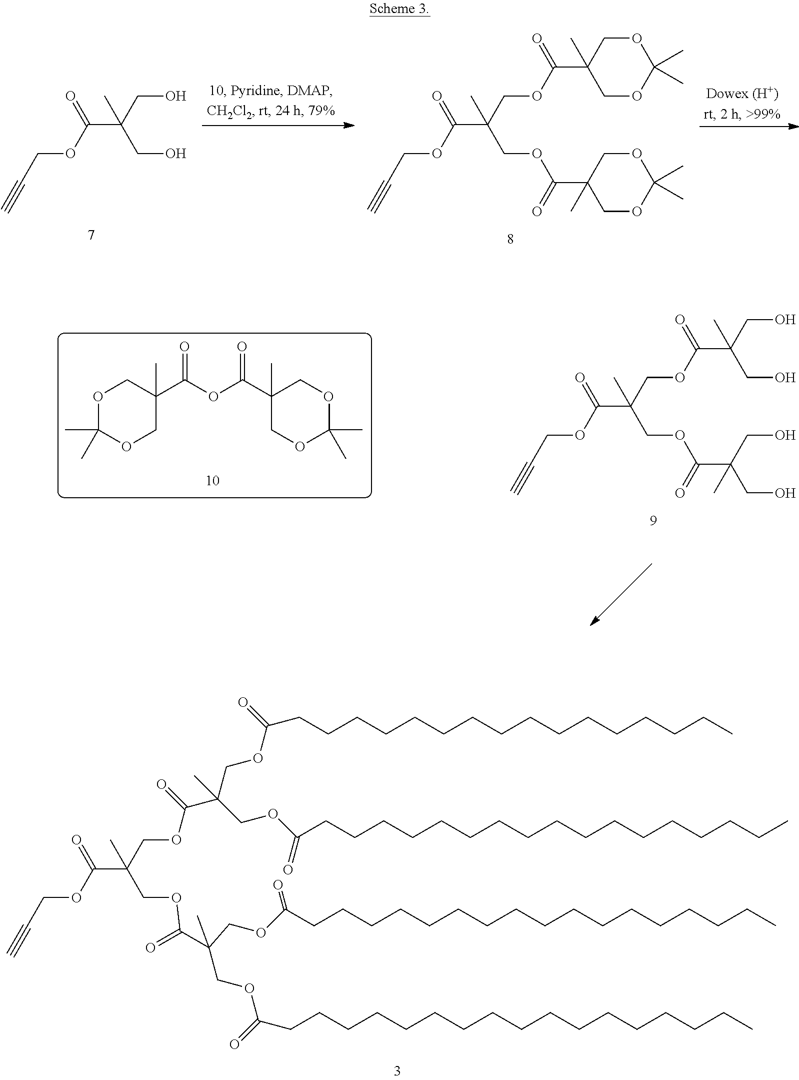

To a stirred solution of prop-2-yn-1-yl 3-hydroxy-2-(hydroxymethyl)-2-methylpropanoate, 7 (8.0 g, 46.5 mmol), DMAP (2.27 g, 18.6 mmol) and pyridine (11.0 g, 139.4 mmol) in CH₂Cl₂ (100 mL) was added 2,2,5-trimethyl-1,3-dioxane-5-carboxylic anhydride, 10 (36.8 g, 111.5 mmol) and the resulting mixture stirred for 24 h. Compound 10 was synthesized according to published procedures (see Ihre, H.; Hult, A.; Fréchet, J. M. J.; Gitsov, I. Macromolecules 1998, 31, 4061; and Gillies, E. R.; Fréchet, J. M. J. J. Am. Chem. Soc. 2002, 124, 14137). The reaction was quenched with 5 mL water and diluted with additional CH₂Cl₂ (200 mL), washed with NaHSO₄ (2×100 mL), Na₂CO₃ (2×100 mL) and brine (50 mL), dried over anhydrous MgSO₄ and concentrated under reduced pressure. The residue was purified by column chromatography (SiO₂, 0-50% EtOAc:hexanes) to afford the compound 8 (17.8 g, 79%). ¹H NMR (CDCl₃) δ 4.72 (d, J=2.6 Hz, 2H), 4.37-4.28 (m, 4H), 4.15 (d, J=12.0 Hz, 4H), 3.62 (d, J=10.9 Hz, 4H), 2.46 (t, J=2.4 Hz, 1H), 1.41 (s, 6H), 1.36 (s, 6H), 1.31 (s, 3H), 1.15 (s, 6H); ¹³C NMR (CDCl₃) δ 173.58, 171.92, 98.18, 77.30, 75.43, 66.06, 66.03, 65.35, 52.76, 46.90, 42.15, 25.11, 22.31, 18.60, 17.68; MALDI-TOF (m/z): [M+Na]⁺ calcd. for C₂₄H₃₆O₁₀Na, 507.2206; found 507.282.

To a stirred solution of 2-methyl-2-((prop-2-yn-1-yloxy)carbonyl)propane-1,3-diyl bis(2,2,5-trimethyl-1,3-dioxane-5-carboxylate), 8 (15.0 g, 31.0 mmol) in MeOH was added DOWEX resin (10 g) and the resulting suspension stirred at 40° C. for 2 h, after which ¹³C NMR showed the disappearance of acetonide quaternary carbon signal (˜98 ppm). The suspension was filtered and the filtrate concentrated under reduced pressure to afford compound 9 (12.46 g, >99%). ¹H NMR (CDCl₃) δ 4.74 (d, J=2.4 Hz, 2H), 4.45 (d, J=11.1 Hz, 2H), 4.29 (d, J=11.2 Hz, 2H), 3.84 (dd, J=10.3, 7.6 Hz, 4H), 3.70 (dd, J=11.4, 9.9 Hz, 4H), 2.71 (s, 4H), 2.49 (t, J=2.4 Hz, 1H), 1.33 (s, 3H), 1.05 (s, 6H); ¹³C NMR (CDCl₃) δ 175.09, 172.33, 77.36, 75.66, 66.97, 66.95, 64.80, 52.86, 49.90, 46.48, 18.04, 17.21; MALDI-TOF (m/z): [M+Na]⁺ calcd. for C₁₈H₂₈O₁₀Na, 427.1580; found 427.275.

To a stirred solution of compound 9, DMAP and pyridine in CH₂Cl₂ (50 mL) was added stearic anhydride and the resulting mixture stirred for 12 h. The reaction mixture was diluted with additional CH₂Cl₂ (50 mL), washed with 1N HCl (3×50 mL), dried over anhydrous MgSO₄, filtered and filtrate concentrated under reduced pressure. The residue was purified by column chromatography (SiO₂, 0-50% EtOAc:hexanes) to afford compound 3 (6.1 g, 88%). Compound 3 was further purified by repeated precipitation from CHCl₃/MeOH). ¹H NMR (500 MHz, CDCl₃) b 4.71 (d, J=2.4 Hz, 2H), 4.28 (d, J=11.1 Hz, 2H), 4.24 (d, J=11.1 Hz, 2H), 4.22-4.12 (m, 8H), 2.50 (t, J=2.0 Hz, 1H), 2.28 (t, J=7.6 Hz, 8H), 1.62-1.54 (m, 8H), 1.31-1.23 (m, 115H), 1.22 (s, 6H), 0.87 (t, J=6.7 Hz, 12H); ¹³C NMR (CDCl₃) b 173.33, 172.20, 171.56, 77.21, 75.67, 65.75, 65.14, 52.90, 46.81, 46.56, 34.18, 32.08, 29.86, 29.83, 29.81, 29.79, 29.65, 29.51, 29.44, 29.29, 25.01, 22.84, 17.93, 17.60, 14.26; MALDI-TOF (m/z): [M+Na]⁺ calcd. for C₉₀H₁₆₄O₁₄Na, 1492.2019; found 1491.808.

Compound 4 was made according to following scheme 4.

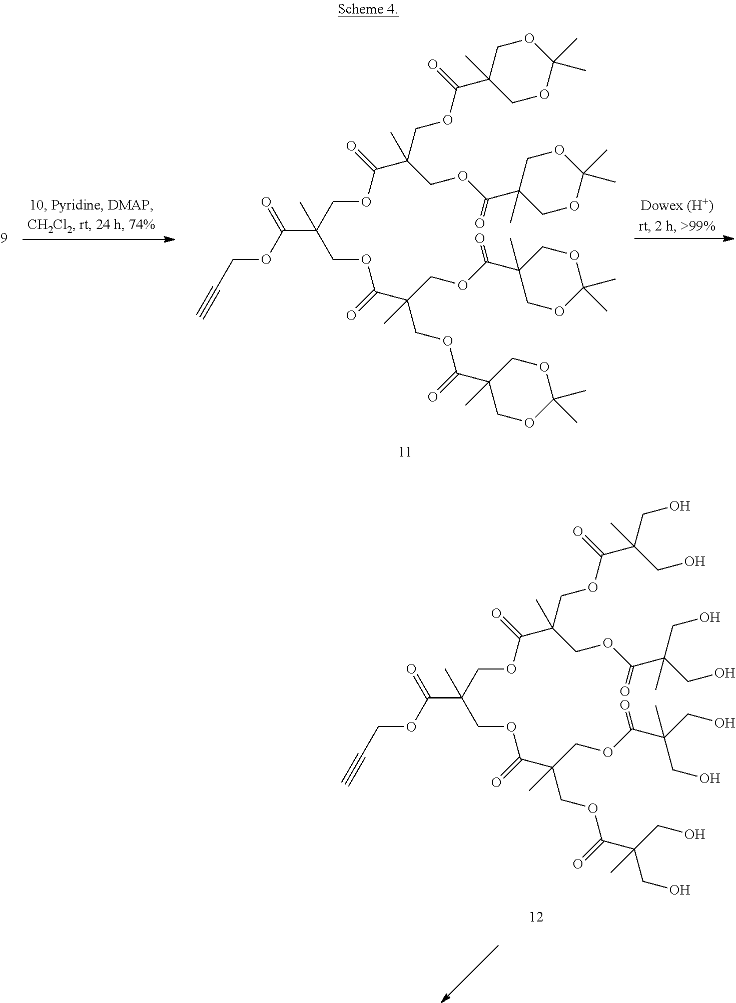

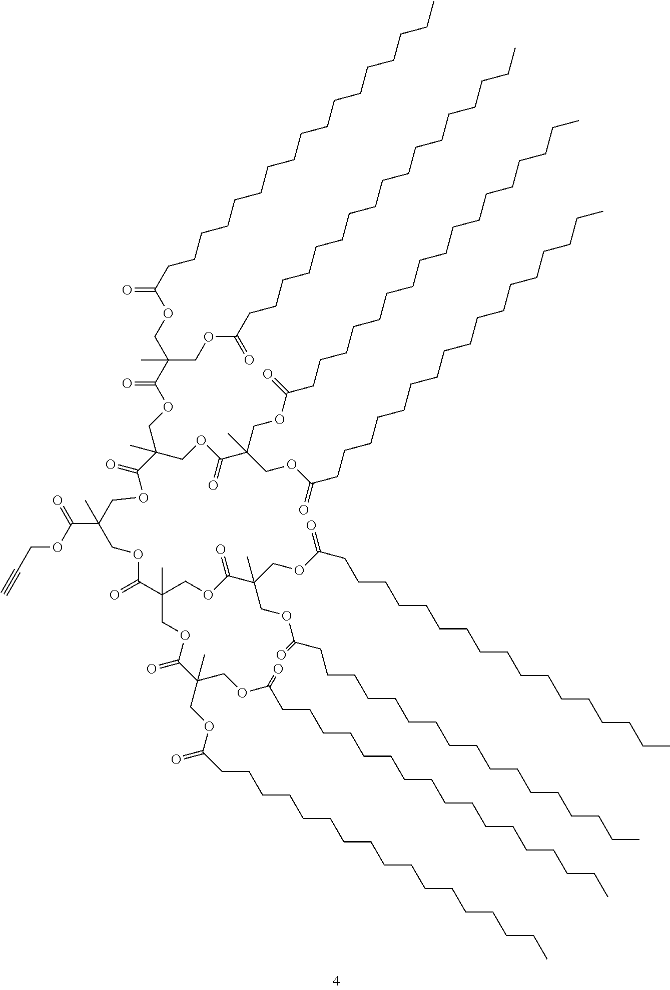 [SMILES: C#CCOC(=O)C(C)(COC(=O)C(C)(COC(=O)C(C)(COC(=O)CCCCCCCCCCCCCCCCC)COC(=O)CCCCCCCCCCCCCCCCC)COC(=O)C(C)(COC(=O)CCCCCCCCCCCCCCCCC)COC(=O)CCCCCCCCCCCCCCCCC)COC(=O)C(C)(COC(=O)C(C)(COC(=O)CCCCCCCCCCCCCCCCC)COC(=O)CCCCCCCCCCCCCCCCC)COC(=O)C(C)(COC(=O)CCCCCCCCCCCCCCCCC)COC(=O)CCCCCCCCCCCCCCCCC]

Compound 11 was synthesized according to the procedure associated with Scheme 3, except that compound 9 was used instead of compound 7. 5.8 g of compound 11 was obtained (74%). ¹H NMR (CDCl₃) δ 4.73 (d, J=2.4 Hz, 2H), 4.34-4.26 (m, 10H), 4.22 (d, J=11.1 Hz, 2H), 4.13 (d, J=12.0 Hz, 8H), 3.61 (d, J=13.2 Hz, 8H), 2.53 (t, J=2.5 Hz, 1H), 1.40 (s, 12H), 1.34 (s, 12H), 1.29 (s, 3H), 1.27 (s, 6H), 1.13 (s, 12H); ¹³C NMR (CDCl₃) δ 173.61, 171.96, 171.51, 98.23, 77.27, 75.82, 66.10, 66.06, 65.08, 52.97, 47.02, 46.80, 42.18, 25.38, 22.11, 18.63, 17.79, 17.65; MALDI-TOF (m/z): [M+Na]⁺ calcd. for C₅₀H₇₆O₂₂Na, 1051.4726; found 1051.341.

Compound 12 was synthesized from compound 11 under conditions described for the conversion of compound 8 to compound 9. 4.2 g of compound 12 was obtained (>99%). ¹H NMR (CDCl₃) δ 4.79 (d, J=2.5 Hz, 2H), 4.37-4.22 (m, 12H), 3.67 (dd, J=10.9, 2.9 Hz, 8H), 3.60 (d, J=10.9 Hz, 8H), 2.99 (t, J=2.5 Hz, 1H), 1.32 (s, 3H), 1.30 (s, 6H), 1.15 (s, 12H); ¹³C NMR (CDCl₃) δ 175.78, 173.62, 173.04, 78.48, 77.00, 67.12, 66.07, 65.73, 53.69, 51.65, 49.85, 47.83, 18.18, 17.92, 17.25.

Compound 4 was synthesized from compound 12 under conditions described for the conversion of compound 9 to compound 3. 4.04 g of compound 4 (89%) was obtained. ¹H NMR (CDCl₃) δ 4.72 (d, J=2.5 Hz, 2H), 4.29 (d, J=11.1 Hz, 2H), 4.25-4.12 (m, 24H), 2.51 (t, J=2.1 Hz, 1H), 2.27 (t, J=7.6 Hz, 16H), 1.64-1.50 (m, 16H), 1.32-1.21 (m, 233H), 1.21 (s, 12H), 0.86 (t, J=6.8 Hz, 24H); ¹³C NMR (CDCl₃) δ 173.26, 172.14, 171.56, 171.41, 77.36, 75.74, 66.33, 65.36, 65.02, 52.94, 46.85, 46.77, 46.50, 34.15, 32.07, 29.86, 29.84, 29.81, 29.67, 29.51, 29.46, 29.30, 25.00, 22.83, 17.93, 17.64, 17.56, 14.25; MALDI-TOF (m/z): [M+Na]⁺ calcd. for C₁₈₂H₃₃₂O₃₀Na, 3021.4351; found 3021.622.

Compounds 5a or 5b were coupled to compounds 1-4 to form compounds 13-17 in accordance with the following scheme S2.

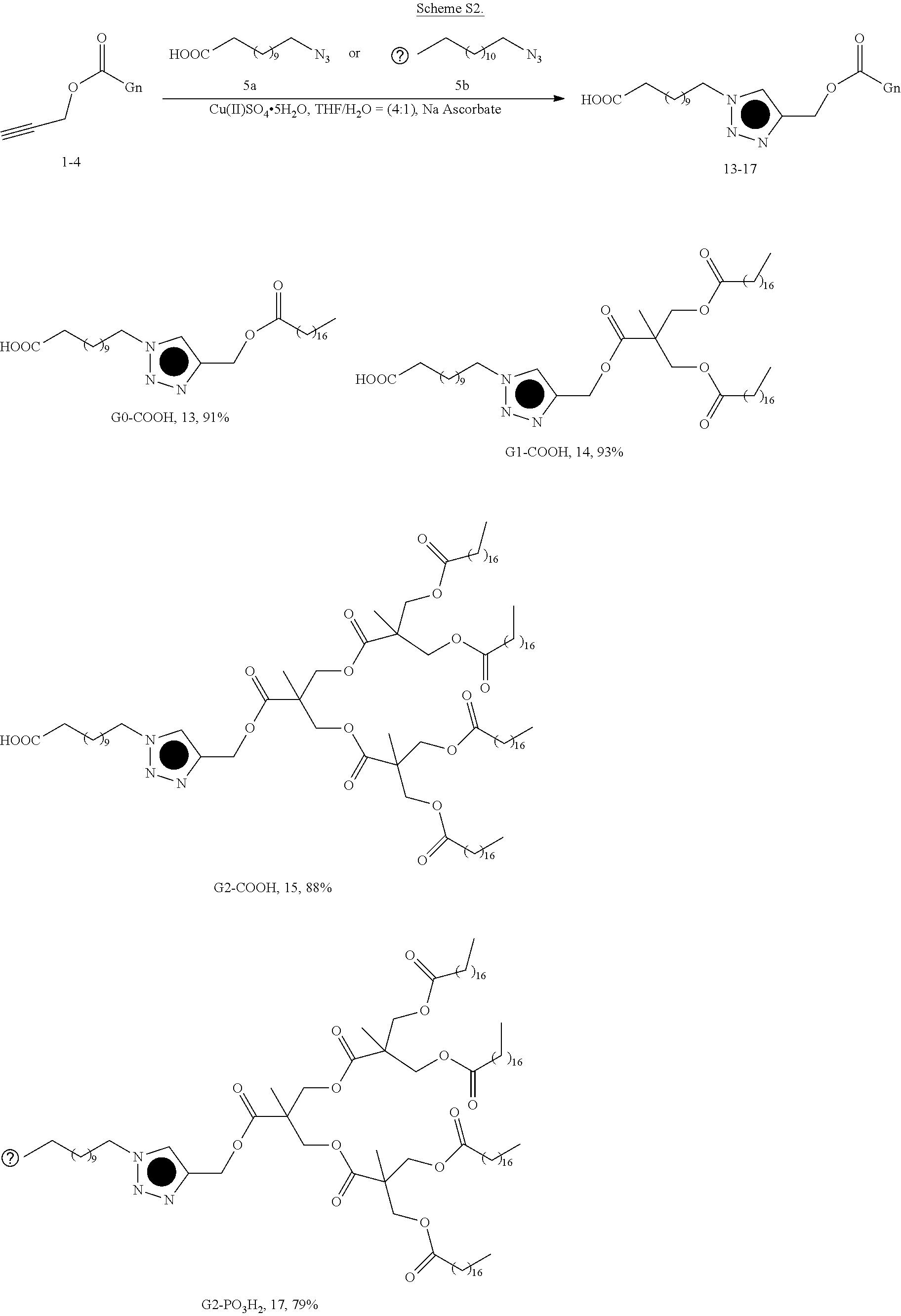

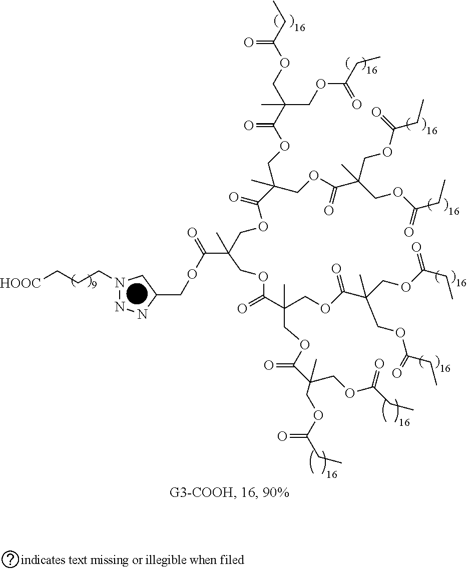

In general, to a stirred solution of compound 5a or 5b (4.14 mmol), prop-2-yn-1-yl stearate (1.33 g, 4.14 mmol) and CuSO₄.5H₂O (0.42 g, 1.66 mmol) in THF/H₂O=4:1 (8 mL) was added sodium ascorbate (0.44 g, 2.22 mmol) and the resulting mixture stirred at 65° C. for 6 h under microwave irradiation (constant temperature mode). The solvent was evaporated, residue was dissolved in CHCl₃ (100 mL) and washed with 1N HCl (3×100 mL). The organic layer was dried over anhydrous Na₂SO₄, filtered and the filtrate concentrated under reduced pressure to afford the desired compound. In case of 15-17 the residue was redissolved in smallest possible amount of warm CHCl₃ and mixed with MeOH to induce the precipitation. The precipitate was collected by filtration and dried to obtain the corresponding compound.

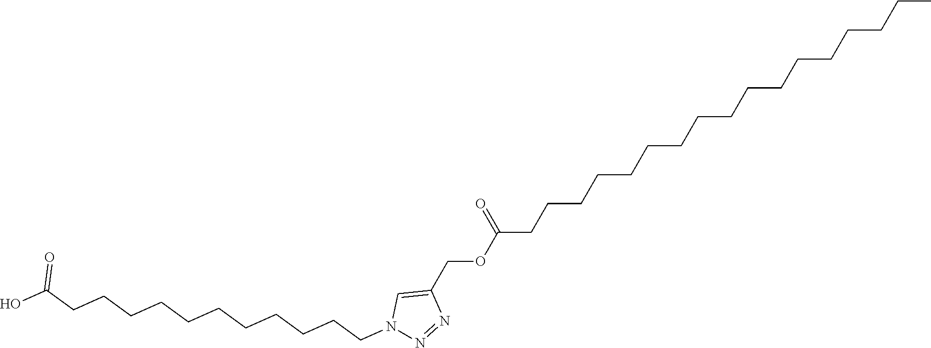 [SMILES: CCCCCCCCCCCCCCCCCC(=O)OCc1cn(CCCCCCCCCCCC(=O)O)nn1]

### 12-(4-((Stearoyloxy)methyl)-1H-1,2,3-triazol-1-yl)dodecanoic acid 13

Prepared according to the general procedure. White solid (2.12 g, 91%). ¹H NMR (CDCl₃) δ 7.58 (s, 1H), 5.21 (s, 2H), 4.33 (t, J=7.3 Hz, 2H), 2.34 (t, J=7.5 Hz, 2H), 2.31 (t, J=7.7 Hz, 2H), 1.89 (p, J=7.1 Hz, 2H), 1.67-1.56 (m, 4H), 1.34-1.22 (m, 43H), 0.87 (t, J=6.9 Hz, 3H); ¹³C NMR (CDCl₃) δ 178.97, 173.99, 143.06, 123.70, 57.63, 50.56, 34.30, 34.03, 32.07, 30.37, 29.84, 29.82, 29.80, 29.75, 29.60, 29.51, 29.45, 29.41, 29.39, 29.26, 29.25, 29.11, 29.05, 26.55, 24.99, 24.81, 22.84, 14.27; MALDI-TOF (m/z): [M+Na]⁺ calcd. for C₃₃H₆₁N₃O₄Na, 586.4560; found 586.528.

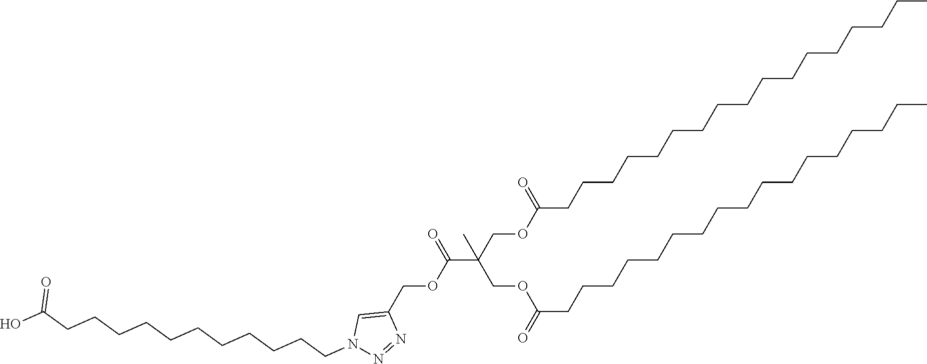 [SMILES: CCCCCCCCCCCCCCCCCC(=O)OCC(C)(COC(=O)CCCCCCCCCCCCCCCCC)C(=O)OCc1cn(CCCCCCCCCCCC(=O)O)nn1]

### 12-(4-(((2-Methyl-3-(stearoyloxy)-2-((stearoyloxy)methyl)propanoyl)oxy)methyl)-1H-1,2,3-triazol-1-yl)dodecanoic acid 14

Prepared according to the general procedure. White solid (0.9 g, 93%). ¹H NMR (CDCl₃) δ 7.57 (s, 1H), 5.25 (s, 2H), 4.33 (t, J=7.4 Hz, 2H), 4.21 (q, J=11.0 Hz, 4H), 2.35 (t, J=7.5 Hz, 2H), 2.24 (t, J=7.6 Hz, 4H), 1.94-1.85 (m, 2H), 1.63 (p, J=7.4 Hz, 2H), 1.56 (p, J=7.4 Hz, 4H), 1.34-1.23 (m, 70H), 1.21 (s, 3H), 0.87 (t, J=6.9 Hz, 6H); ¹³C NMR (CDCl₃) δ 178.85, 173.39, 172.94, 142.49, 123.73, 77.42, 77.16, 76.91, 65.23, 58.57, 50.59, 46.48, 34.21, 34.01, 32.07, 30.39, 29.85, 29.81, 29.77, 29.64, 29.51, 29.47, 29.42, 29.27, 29.12, 29.06, 26.58, 24.99, 24.82, 22.83, 17.87, 14.26; MALDI-TOF (m/z): [M+Na]⁺ calcd. for C₅₆H₁₀₃N₃O₈Na, 968.7643; found 969.021.

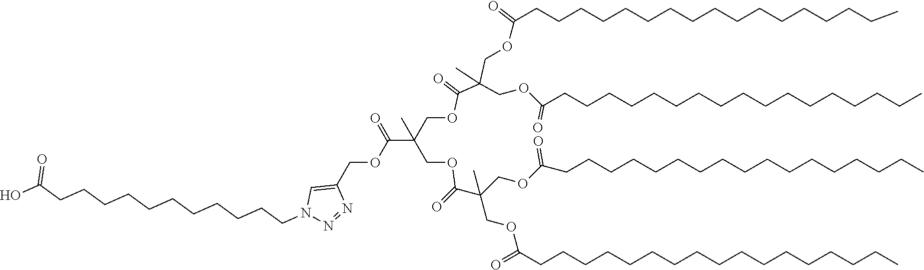 [SMILES: CCCCCCCCCCCCCCCCCC(=O)OCC(C)(COC(=O)CCCCCCCCCCCCCCCCC)C(=O)OCC(C)(COC(=O)C(C)(COC(=O)CCCCCCCCCCCCCCCCC)COC(=O)CCCCCCCCCCCCCCCCC)C(=O)OCc1cn(CCCCCCCCCCCC(=O)O)nn1]

### 12-(4-(((2-Methyl-3-((2-methyl-3-(stearoyloxy)-2-((stearoyloxy)methyl)propanoyl)oxy)-2-(((2-methyl-3-(stearoyloxy)-2-((stearoyloxy)methyl)propanoyl)oxy)methyl)propanoyl) oxy)methyl)-1H-1,2,3-triazol-1-yl)dodecanoic acid 15

Prepared according to the general procedure. White solid (1.2 g, 88%). ¹H NMR (CDCl₃) δ 7.69 (s, 1H), 5.25 (s, 2H), 4.36 (t, J=7.3 Hz, 2H), 4.25 (d, J=11.0 Hz, 2H), 4.21 (d, J=11.1 Hz, 2H), 4.17-4.09 (m, 7H), 2.33 (t, J=7.5 Hz, 2H), 2.28 (t, J=7.6 Hz, 8H), 1.97-1.85 (m, 2H), 1.66-1.52 (m, 10H), 1.34-1.22 (m, 126H), 1.22 (s, 3H), 1.17 (s, 6H), 0.87 (t, J=6.9 Hz, 12H); ¹³C NMR (CDCl₃) δ 178.53, 173.39, 172.28, 172.14, 65.66, 65.08, 58.54, 50.61, 46.79, 46.47, 34.17, 33.97, 32.07, 30.39, 29.86, 29.83, 29.81, 29.79, 29.66, 29.51, 29.47, 29.45, 29.43, 29.29, 29.12, 29.08, 26.60, 25.00, 24.81, 22.83, 17.90, 17.65, 14.26; MALDI-TOF (m/z): [M+Na]⁺ calcd. for C₁₀₂H₁₈₇N₃O₁₆Na, 1733.3809; found 1733.595.

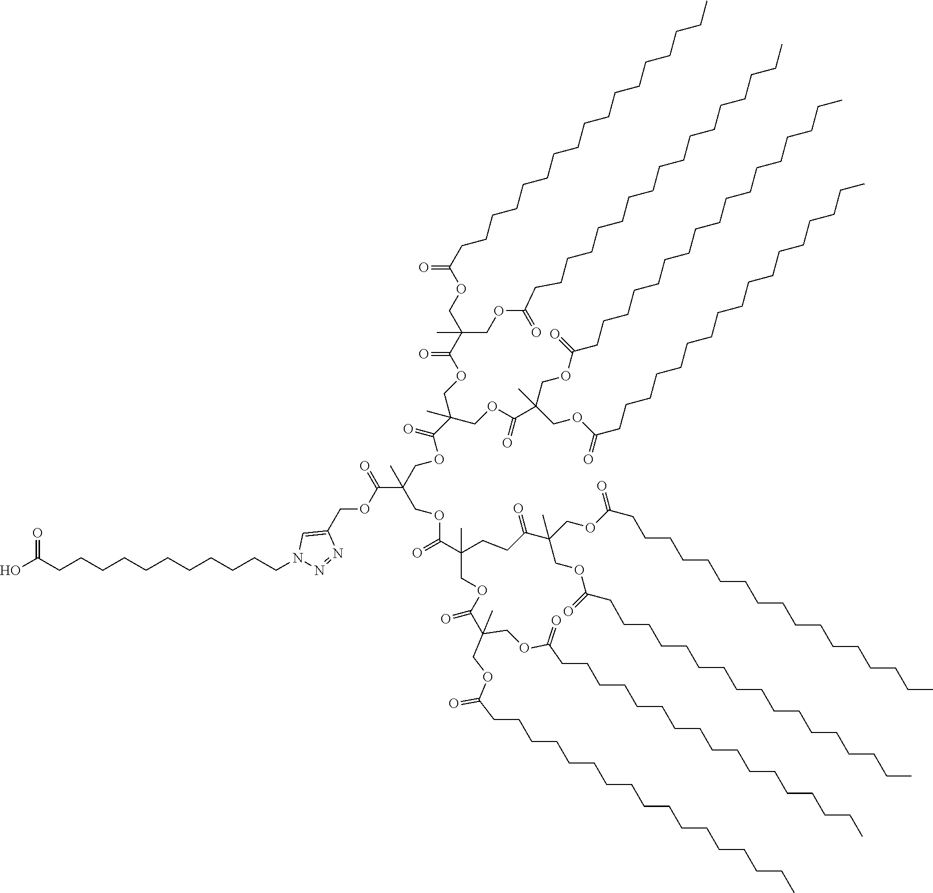 [SMILES: CCCCCCCCCCCCCCCCCC(=O)OCC(C)(COC(=O)CCCCCCCCCCCCCCCCC)C(=O)CCC(C)(COC(=O)C(C)(COC(=O)CCCCCCCCCCCCCCCCC)COC(=O)CCCCCCCCCCCCCCCCC)C(=O)OCC(C)(COC(=O)C(C)(COC(=O)C(C)(COC(=O)CCCCCCCCCCCCCCCCC)COC(=O)CCCCCCCCCCCCCCCCC)COC(=O)C(C)(COC(=O)CCCCCCCCCCCCCCCCC)COC(=O)CCCCCCCCCCCCCCCCC)C(=O)OCc1cn(CCCCCCCCCCCC(=O)O)nn1]

Compound 16. Prepared according to the general procedure. White solid (0.6 g, 79%). ¹H NMR (CDCl₃) δ 7.71 (s, 1H), 5.25 (s, 2H), 4.36 (t, J=7.3 Hz, 2H), 4.32-4.09 (m, 28H), 2.34 (t, J=7.4 Hz, 2H), 2.28 (t, J=7.6 Hz, 16H), 1.96-1.85 (m, 2H), 1.65-1.54 (m, 18H), 1.33-1.22 (m, 241H), 1.21 (s, 12H), 1.19 (s, 6H), 0.87 (t, J=6.8 Hz, 24H); ¹³C NMR (126 MHz, CDCl₃) δ 178.78, 173.33, 172.18, 172.14, 171.56, 66.27, 65.33, 65.02, 58.68, 50.59, 46.80, 46.74, 46.50, 34.17, 33.75, 32.08, 30.42, 29.88, 29.87, 29.83, 29.69, 29.52, 29.49, 29.38, 29.32, 29.21, 29.06, 26.56, 25.02, 24.82, 22.85, 17.95, 17.60, 14.27; MALDI-TOF (m/z): [M+Na]⁺ calcd. for C₁₉₄H₃₅₅N₃O₃₂Na, 3262.6141; found 3262.661.

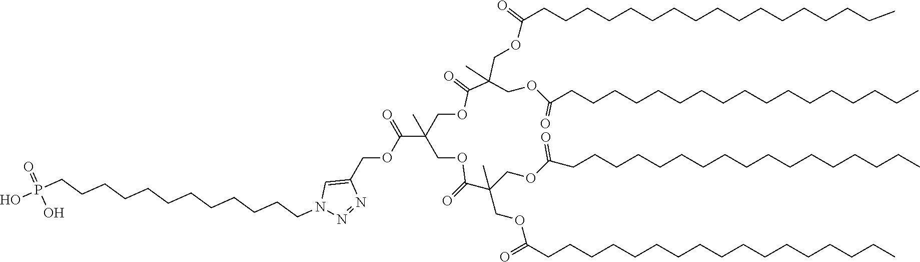 [SMILES: CCCCCCCCCCCCCCCCCC(=O)OCC(C)(COC(=O)CCCCCCCCCCCCCCCCC)C(=O)OCC(C)(COC(=O)C(C)(COC(=O)CCCCCCCCCCCCCCCCC)COC(=O)CCCCCCCCCCCCCCCCC)C(=O)OCc1cn(CCCCCCCCCCCCP(=O)(O)O)nn1]

### (11-(4-(((2-Methyl-3-((2-methyl-3-(stearoyloxy)-2-((stearoyloxy)methyl)propanoyl)oxy)-2-(((2-methyl-3-(stearoyloxy)-2-((stearoyloxy)methyl)propanoyl)oxy)methyl)propanoyl)oxy) methyl)-1H-1,2,3-triazol-1-yl)undecyl)phosphonic acid 17

Prepared according to the general procedure. White solid (0.5 g, 90%). ¹H NMR (CDCl₃) δ 7.72 (s, 1H), 5.25 (s, 2H), 4.36 (t, J=7.3 Hz, 2H), 4.23 (q, J=11.1 Hz, 4H), 4.14 (t, J=8.4 Hz, 8H), 2.27 (t, J=7.5 Hz, 8H), 1.98-1.83 (m, 2H), 1.83-1.67 (m, 2H), 1.57 (p, J=7.3 Hz, 11H), 1.47-1.18 (m, 133H), 1.17 (s, 6H), 0.87 (t, J=6.7 Hz, 12H); ¹³C NMR (CDCl₃) δ 173.34, 172.27, 172.13, 65.64, 65.09, 58.48, 50.71, 46.79, 46.49, 34.16, 32.06, 30.71, 30.60, 30.39, 29.84, 29.82, 29.80, 29.78, 29.64, 29.61, 29.52, 29.49, 29.44, 29.28, 29.21, 29.14, 26.67, 25.00, 22.82, 22.24, 17.89, 17.65, 14.24; MALDI-TOF (m/z): [M+Na]⁺ calcd. for C₁₀₂H₁₉₀N₃O₁₇Na, 1783.3731; found 1783.696.

### Example 2. Production of Inventive Hybrid Nanoparticles

Nickel nanocrystals were prepared as follows. 1 mmol of Ni (II) acetylacetonate were dissolved in 15 mL benzyl ether together with 30 mmol oleylamine. The mixture was evacuated at room temperature for 5 minutes before injection of 30 mmol of trioctylphosphine. The reaction mixture was heated to 80° C. and kept under vacuum for 30 minutes. Then, the temperature was increased to 230° C. at a rate of 10° C./min. After 30 minutes, the reaction mixture was cooled down to the room temperature and Ni NCs were precipitated by adding acetone. Ni NCs were redispersed in toluene and washed with acetone for three times. 11-nm Mn_{0.08}Zn_{0.33}Fe_{2.59}O₄ NCs were prepared as follows. 3 mmol of Mn (II) acetylacetonate, 6 mmol of zinc (II) acetylacetonate, 12 mmol of iron (III) acetylacetonate, 100 mmol of oleic acid, 112 mmol of oleyl amine, and 72 mL of 1-octadecene were mixed in a 250 mL flask. The reaction mixture was heated to 110° C. and kept under vacuum for two hours. Then, the temperature was increased to 300° C. at a rate of 11° C./min. After two hours, the reaction mixture was cooled down to the room temperature and resulting NCs were precipitated by adding isopropanol. The manganese zinc ferrite NCs were redispersed in hexane and washed further using isopropanol three times. The ratio between zinc and iron is measured by inductive coupling plasma optical emission spectrometry (ICP-OES).

Ligand exchange of Ni NCs was performed using 10 mg of any one of compounds 13-16 dissolved in 5 mL of chloroform added to 1 mL of Ni NCs in toluene (10 mg/mL). The reaction was stirred for 30 minutes at room temperature and stopped by precipitation of the Ni NCs with acetone. The Ni NCs were redispersed in toluene and washed with acetone for two times.

Ligand exchange of Mn_{0.08}Zn_{0.33}Fe_{2.59}O₄ NCs was conducted as follows. First, 150 mg of compound 17 was dissolved in 5 mL of hexane at 40° C. When the solution became transparent and colorless, 150 mg of NCs in 5 mL of hexane was added into the solution with compound 17 and kept at 40° C. After overnight stirring, 30 mL of isopropanol was added into the solution to precipitate out the ligand exchanged NCs. The precipitate was redispersed in 5 mL of hexane. Then, 20 mL of isopropanol was added into the NC solution again to remove any excess compound. The final product was dissolved and kept in hexane.

### Example 3. Characteristics of Ni Hybrid Nanoparticles

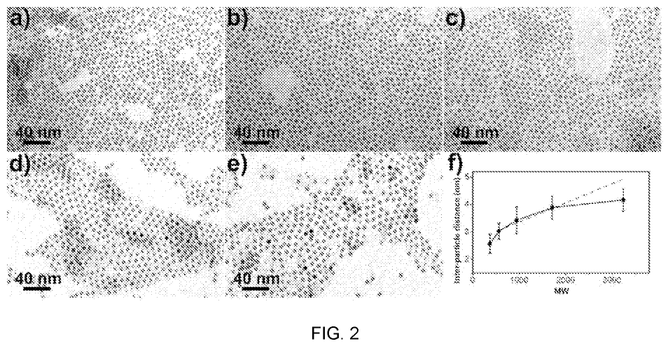

The inventive hybrid Ni NCs made in Example 2 were drop-casted and analyzed by transmission electron microscope (TEM). FIG. 2 shows TEM images of monolayers of as-synthesized Ni NCs and dendron-coated Ni NCs demonstrating an increasing inter-particle separation as a function of generation.

The data for inter-particle spacing, deduced from TEM images revealed a nonlinear relationship between the molecular weight (Mw) of dendrons, compounds 13-16, and an observed inter-particle distance. G0 corresponds to compound 13, G1 to compound 14, G2 to compound 15, and G3 corresponds to compound 16. This can be clearly seen when an inter-particle separation is plotted as a function of Mw (FIG. 2f) revealing that in such architecture of dendrons, the G2 induces the largest inter-particle separation per Mw and therefore can be considered as the most optimal geometry.

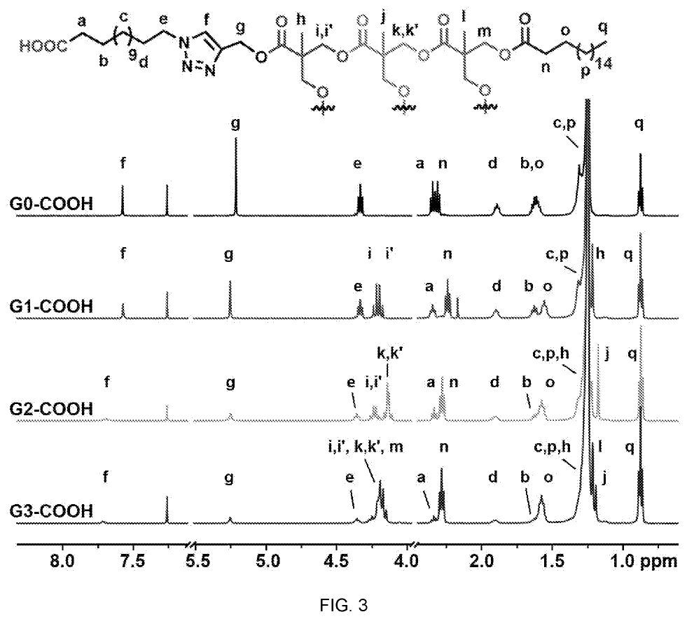

This observation is in good agreement with ¹H NMR data of pure dendrimers. FIG. 3 shows the overlay of NMR spectra obtained from free dendrons in CDCl₃ solution and allows one to follow the evolution of specific signals as a function of generation. The signals of core moiety (signals f, g, e and d in FIG. 3) become progressively broader as a function of generation. This is especially clear in G2 and G3, indicating reduced internal conformational mobility, which is a sign of formation of dense, three dimensional, globular structures. It is noteworthy that the effect starts as low as G2, which means that less number of synthetic steps is required to access the molecule that has the most optimal geometry within the series.

### Example 4. Characteristics of MZF Hybrid Nanoparticles

In the case of Mn_{0.08}Zn_{0.33}Fe_{2.59}O₄ NCs nanocrystals, it was found that compounds 13-16 resulted in equilibrium between the surface bound ligands, such as oleic acid, and the incoming dendrimers. Under the tested conditions, there would only be a small portion of oleic acid exchanged with dendron as evidenced by much smaller final inter-particle separations compared to the inter-particle separations observed in Ni NCs using the same ligands. This may be due to similar binding strength of carboxylic acid head groups present in both oleic acid and in the dendrons, leading to equilibrium before the majority of existing ligand is exchanged. However, it was found that compound 17, which is analogous to compound 15, allowed for suitable exchange by virtue of a phosphonic acid head group.

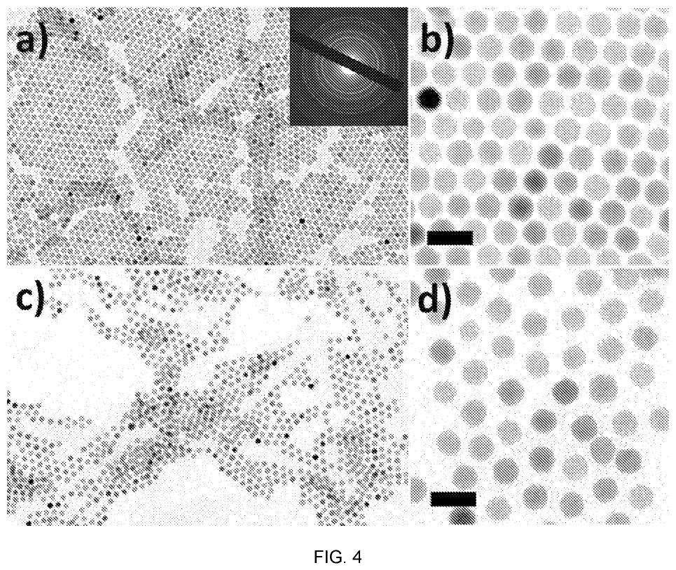

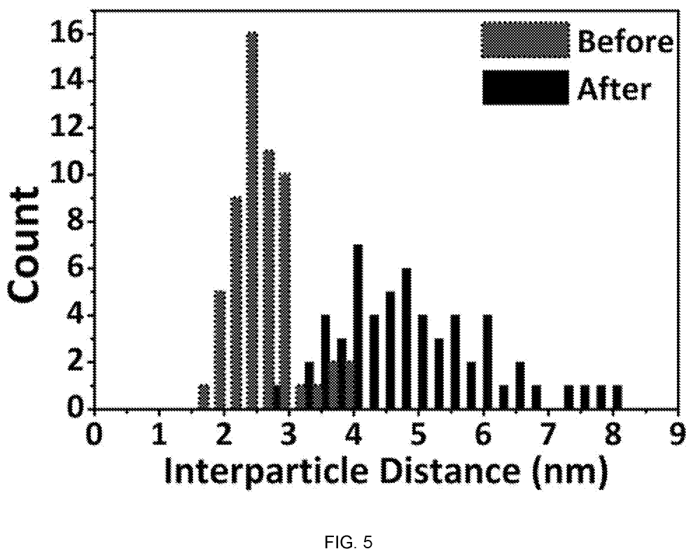

FIG. 4 shows TEM images of MZF NCs before and after ligand exchange that display dramatic, controlled increase in inter-particle distance compared to the surface capping commercial ligands (i.e. oleic acid), by which they were synthesized. As can be observed in the low (FIG. 4a) and high (FIG. 4b) magnification images, the NCs are highly monodisperse with the standard deviation of only 3.7%. From the selected area electron diffraction pattern (inset of FIG. 4a), it is clearly observed that the NCs possess spinel crystal structure. Before the ligand exchange, the average inter-particle distance is 2.5 nm with the standard deviation of 15.7% as measured from TEM data of drop-casted solution. In FIGS. 4c and 4d, the TEM images of MZF NCs at high magnification and low magnification after the ligand exchange with compound 17 are shown, respectively. It is apparent that the inter-particle distance is extended after the ligand exchange. As deduced from the TEM image, the average inter-particle distance has now become 5.0 nm with 23.1% of standard deviation, which means that the inter-particle distance is increased by twofold. FIG. 5 shows the distribution of inter-particle distance before and after ligand exchange.

### Example 5. Magnetic Properties of MZF Hybrid Nanoparticles

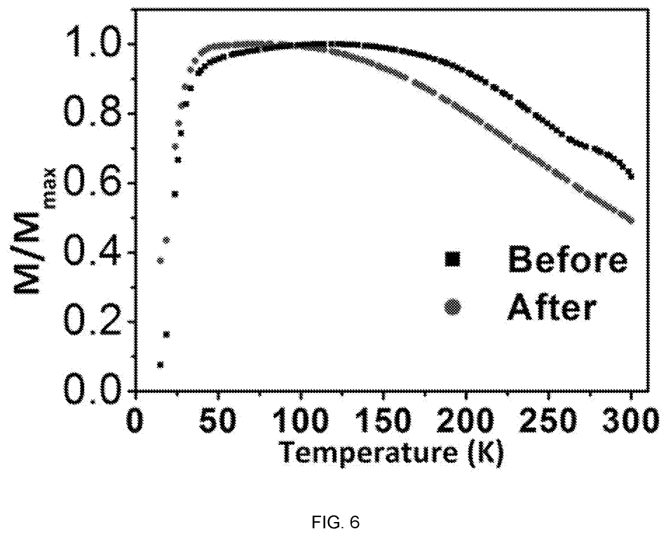

The magnetic properties of NCs were studied by means of DC and AC magnetization. After the ligand exchange, the effect of increased inter-particle distance on DC and AC magnetic properties of the NCs was analyzed. In FIG. 6, the normalized zero-field-cooled (ZFC) curves of MZF NCs before (squares) and after (circles) the ligand exchange are shown. Blocking temperature (T_{B}), where the ferromagnetic to superparamagnetic transition occurs, of the NCs is assigned as the maximum point of the ZFC curve, and T_{B} is drastically reduced from 114 K to 75 K after the ligand exchange with compound 17, indicating the reduced dipolar interactions between MZF NCs. Due to the increased inter-particle distance, the dipole-dipole interaction between the NCs decreases, and therefore the energy barrier for thermally induced spin re-orientation reduces, resulting in the lower T_{B}.

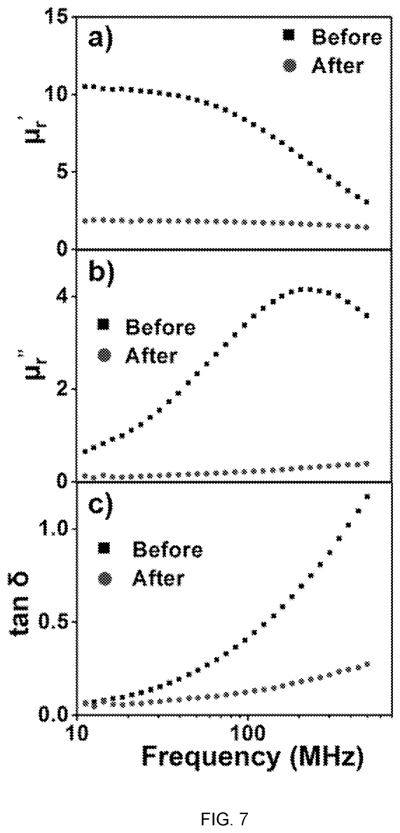

For the dynamic magnetic properties of the NCs, AC magnetic permeability (μ) was examined by the relative magnetic permeability, μᵣ=μᵣ′−jμᵣ″. In this study, the relative permeability (μᵣ) in the frequency range of 10-500 MHz was derived based the one-turn inductor model measured. In FIG. 7a, the real part of the relative permeability (μᵣ′) of MZF NCs decreased from 10 to 2 after the ligand exchange with compound 17, which can be mainly attributed to that the ligand exchange resulted in a significant reduction of volume fraction of the NCs in the dry powder sample.

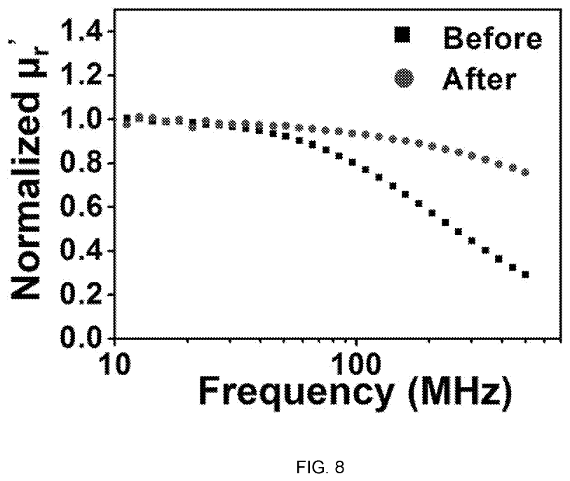

Therefore, the magnetic field flux density in the NC sample becomes less after the ligand exchange, which is exhibited in the reduced μᵣ′. It is worth noting that, however, the μᵣ′ value of the NCs with compound 17 was much more consistent than that of the as-synthesized NCs as can be observed from the normalized μᵣ′ (μᵣ′/μᵣ′ᵢₙᵢₜᵢₐₗ) plot, shown in FIG. 8, where μᵣ′ᵢₙᵢₜᵢₐₗ is the μᵣ′ value at 10 MHz. For example, the normalized μᵣ′ values at 500 MHz were 0.29 and 0.76 for the as-synthesized NCs and the ligand-exchanged NCs, respectively. For the imaginary part of the relative permeability (μᵣ″), the superparamagnetic-ferromagnetic relaxation frequency corresponds to the frequency (ωₘₐₓ) where the pr values reached maximum. Before ligand exchange, the ″values of MZF NCs reach maximum at the frequency of 45 MHz. By contrast, after ligand exchange, the μᵣ″ value shows slight increase without maximum point up to 500 MHz, suggesting the ωₘₐₓ is higher than 500 MHz. The increase in ωₘₐₓ corresponds to a shorter Néel relaxation time (τ_{N}=1/ωₘₐₓ), which is the result of reduced dipole-dipole interaction brought by the ligand exchange process. The increased ωₘₐₓ indicates that the operable frequency range of the NCs is extended toward higher frequencies, which support the suitability of our approach for employing NCs in AC magnetic devices. The significant reduction in r gives rise to a huge change in energy efficiency of the material, which is examined by the loss tangent (tan δ). After the ligand exchange, the MZF NCs show much lower loss tangent values over the whole range of the measurement frequency (FIG. 7c). That is, increased inter-particle distance induces lower dipole-dipole interaction, allowing the magnetic moment of the dendron coated NCs to be more coherent with the external magnetic field than that of the as-synthesized NCs. Since loss tangent is defined as the ratio of the imaginary to the real part of permeability, this result means the reduction of μᵣ″ is much larger than that of μᵣ′.

These results clearly demonstrate the effect of inter-particle spacing on the AC magnetic properties of MZF NCs at radio frequencies. Further optimization of ligand exchanged NCs will be needed to achieve a higher real part of permeability for magnetic applications.

As described herein, significant reductions of μᵣ′, μᵣ″, and tangent loss can be achieved using the inventive compounds complying with formula (I) or (II) due to the decreased volume fraction of the NCs and increased inter-particle spacing after ligand exchange. Importantly, the FMR frequency of the NCs increases from 45 MHz to over 500 MHz, suggesting the potential of this approach to utilize NCs in radio frequencies. The effect of inter-particle spacing on the magnetic behavior provides a way of tuning the DC and AC magnetic properties of NCs.

### Example 6. Thermal Behavior of Compounds Complying with Formula (I) or (II)

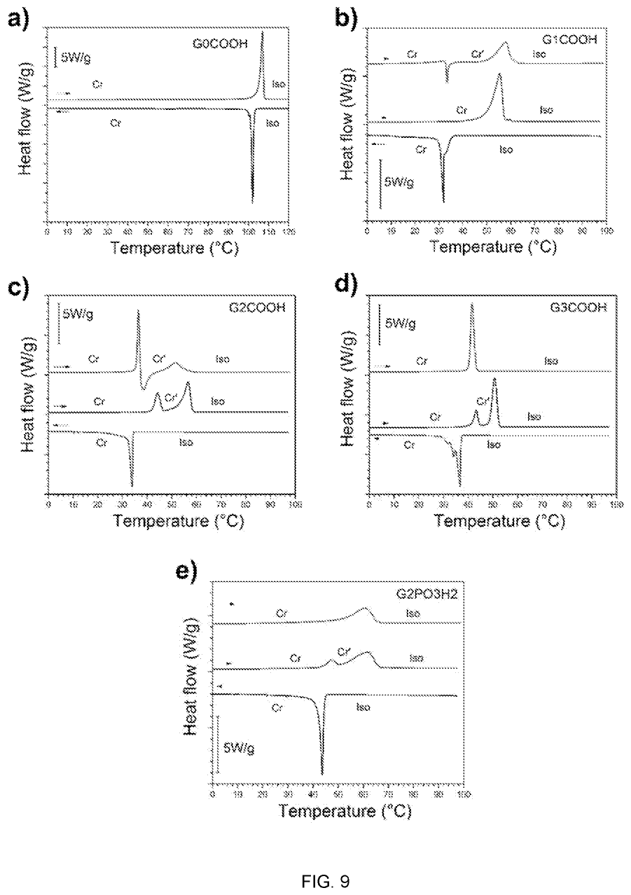

The thermal behavior of the inventive compounds complying with formula (I) or (II) was studied by differential scanning calorimetry (DSC). FIG. 9a-9e shows the DSC traces of compounds 13-17 of Example 1, respectively. The DSC curves provide information about the behavior of the individual compounds and the thermal states each compound passes through when melted or solidified. “Cr” refers to crystalline phase and “Iso” refers to isotropic liquid.

The DSC analyses are summarized in following Table 1.

TABLE 1
DSC analyses of compounds 13-17.

| Compounds | First heating/Second heating | First cooling |
|---|---|---|
| 13 | Cr 105.3 (106.9) [207.5] Iso | Iso 102.1 (102.8] |
| | | [202.5] Cr |
| 14 | i) Cr 51.1 (55.3) [147.1] Iso | Iso 34.5 (32.0) |
| | ii) Cr 32.9 (33.4 [−9.6] | [76.3) Cr |
| | Cr′ 51.3 (57.9) [74.9] Iso | |
| 15 | i) Cr 42.1 (44.2) [36.4] Cr′ 53.7 | Iso 33.9 (34.3) |
| | (56.5) [75.8] Iso | [73.6] Cr |
| | ii) Cr 36.4 (35.7] [63.7] Cr′ 38.5 | |
| | (38.5) [32.1] 45.6 (51.6) [54.1] Iso | |
| 16 | i) Cr 41.5 (43.3) [—] Cr′ 48.8 (50.7) | Iso 36.7 (37.1) |
| | [125.8] Iso | [96.8] Cr |
| | ii) Cr40.6 (41.6) [97.8] Iso | |
| 17 | i) Cr 44.5 (47.1) [—] Cr′ 53.3 (62.3) | Iso 43.7 (44.4) |
| | [98.1] Iso | [86.1] Cr |
| | ii) Cr 52.6 (61.3) [59.7] Iso | |

ONSET temperature: T_{ONSET}/° C.;
Peak temperature: (T_{PEAK}/° C.);
Melting enthalpy: [ΔH/J g⁻¹]

1. A hybrid nanoparticle comprising:
(a) a metallic core or a metal oxide core, and
(b) at least one dendron attached to the surface of the metallic core or metal oxide core,
wherein the at least one dendron is derived from a compound complying with formula (I) or (II): 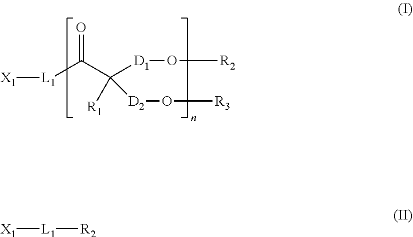
wherein
each occurrence of R₁ is H or C₁-C₂₀ alkyl,
each occurrence of D₁ and D₂ are each, independently, C₁-C₂₀ alkylene,
each occurrence of L₁ is C₁-C₂₀ alkylene,
each occurrence R₂ and R₃ are each, independently, H, C₁-C₃₈ alkyl, C₂-C₃₈ alkenyl, or C₂-C₃₈ alkynyl,
n is from 1 to 6;
X₁ is —COOR₅, —PO₃R₆R₇, —CN, 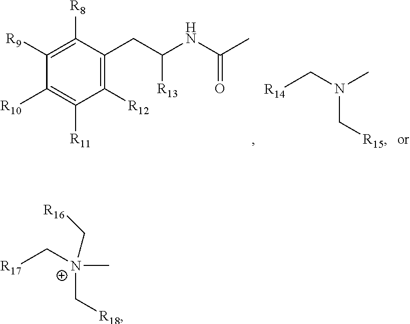
wherein
R₅, R₆, and R₇, are each, independently, H or hydrocarbyl;
R₅, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl; and
wherein R₁, D₁, and D₂, L₁, R₂, and R₃, are each optionally interrupted by one or more divalent moieties.

2. The hybrid nanoparticle according to claim 1, wherein the metallic core comprises a transition metal.

3. The hybrid nanoparticle according to claim 1, wherein the metallic core comprises nickel.

4. The hybrid nanoparticle according to claim 1, wherein the metal oxide core comprises at least 3 different transition metals.

5. (canceled)

6. The hybrid nanoparticle according to claim 1, wherein n is from 1 to 3.

7. (canceled)

8. The hybrid nanoparticle according to claim 1, wherein X₁ is —COOR₅ or —PO₃R₆R₇.

9. The hybrid nanoparticle according to claim 1, wherein R₁ is methyl.

10. The hybrid nanoparticle according to claim 1, wherein D₁ and D₂ are each methylene.

11. The hybrid nanoparticle according to claim 1, wherein R₂ and R₃ are each C₁₇-alkyl interrupted by

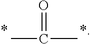

12. The hybrid nanoparticle according to claim 1, wherein L₁ is C₁₂-alkylene interrupted by —O— and

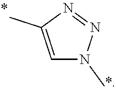

13. A film comprising a plurality of hybrid nanoparticles according to claim 1.

14. A compound complying with formula (I) or (II): 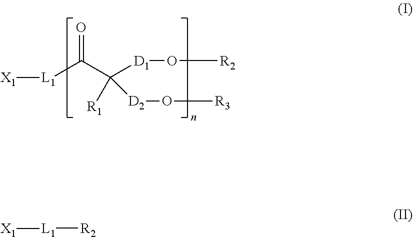
wherein
each occurrence of R₁ is H or C₁-C₂₀ alkyl,
each occurrence of D₁ and D₂ are each, independently, C₁-C₂₀ alkylene,
each occurrence of L₁ is C₁-C₂₀ alkylene,
each occurrence R₂ and R₃ are each, independently, H, C₁-C₃₈ alkyl, C₂-C₃₈ alkenyl, or C₂-C₃₈ alkynyl,
n is from 1 to 6;
X₁ is —COOR₅, —PO₃R₆R₇, —CN, 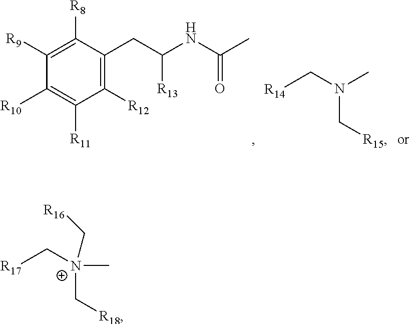
wherein
R₅, R₆, and R₇, are each, independently, H or hydrocarbyl;
R₈, R₉, R₁₀, R₁₁, R₁₂, R₁₃, R₁₄, R₁₅, R₁₆, R₁₇, and R₁₈ are each, independently, H, OH, CN, halogen, COOH, or hydrocarbyl; and
wherein R₁, D₁, and D₂, L₁, R₂, and R₃, are each optionally interrupted by one or more divalent moieties.

15. The compound according to claim 14, wherein n is from 1 to 3.

16. (canceled)

17. The compound according to claim 14, wherein X₁ is —COOR₅ or —PO₃R₆R₇.

18. The compound according to claim 14, wherein R₁ is methyl.

19. The compound according to claim 14, wherein D₁ and D₂ are each methylene.

20. The compound according to claim 14, wherein R₂ and R₃ are each C₁₇-alkyl interrupted by

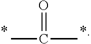

21. The compound according to claim 14, wherein L₁ is C₁₂-alkylene interrupted by —O— and

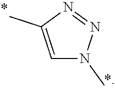

22. A method for tuning the magnetic permeability of a nanoparticle, the method comprising:
contacting the nanoparticle with a compound according to claim 14.

23. The method according to claim 22, wherein the contacting step is a ligand exchange.
